(19) United States
(12) Patent Application Publication
(10) Pub. No.: US 2017/0330109 A1
(43) Pub. Date: Nov. 16, 2017

(54) PREDICTIVE DRIFT DETECTION AND CORRECTION

(71) Applicant: PurePredictive, Inc., Sandy, UT (US)

(72) Inventors: Jason Maughan, Sandy, UT (US); James Lovell, Provo, UT (US); Richard W. Wellman, Park City, UT (US); Kelly D. Phillipps, Salt Lake City, UT (US)

(73) Assignee: PurePredictive, Inc., Sandy, UT (US)

(21) Appl. No.: 15/597,143

(22) Filed: May 16, 2017

Related U.S. Application Data
(60) Provisional application No. 62/337,140, filed on May 16, 2016.

(51) Int. Cl. G06N 99/00; G06N 5/04

(52) U.S. Cl. CPC G06N 99/005; G06N 5/04

(57) ABSTRACT

Apparatuses, systems, methods, and computer program products are disclosed for drift detection and correction for predictive analytics. A prediction module applies a model to workload data to produce one or more predictive results. Workload data may include one or more records. A model may include one or more learned functions based on training data. A drift detection module detects a drift phenomenon relating to one or more predictive results. A predict-time fix module may modify at least one predictive result in response to a drift phenomenon.

### CROSS-REFERENCES TO RELATED APPLICATIONS

This application claims the benefit of U.S. Provisional Patent Application No. 62/337,140 entitled “PREDICTIVE DRIFT DETECTION AND CORRECTION” and filed on May 16, 2016 for Jason Maughan et al., which is incorporated herein by reference.

### FIELD

The present disclosure, in various embodiments, relates to predictive analytics and more particularly relates to drift detection and correction for predictive analytics.

### BACKGROUND

Data analytics models are typically highly tuned and customized for a particular application. Such tuning and customization often requires pre-existing knowledge about the particular application, and can require the use of complex manual tools to achieve this tuning and customization. For example, an expert in a certain field may carefully tune and customize an analytics model for use in the expert's field using a manual tool.

While a highly tuned, expert customized analytics model may be useful for a particular application or field, because of the high level of tuning and customization, the analytics model is typically useless or at least inaccurate for other applications and fields. Conversely, a general purpose analytics framework typically is not specialized enough for most applications without substantial customization.

Additionally, characteristics of a client's data may drift or change over time. For example, a client may alter the way it collects data (e.g., adding fields, removing fields, encoding the data differently, or the like), demographics may change over time, a client's locations and/or products may change, a technical problem may occur in calling a predictive model, or the like. Such changes in data may cause a predictive model to become less accurate over time, even if the predictive model was initially accurate.

### SUMMARY

Apparatuses are presented for drift detection and correction for predictive analytics. In one embodiment, a prediction module applies a model to workload data to produce one or more predictive results. In certain embodiments, workload data may include one or more records. In further embodiments, a model may include one or more learned functions based on training data. In one embodiment, a drift detection module detects a drift phenomenon relating to one or more predictive results. In a certain embodiment, a predict-time fix module modifies at least one predictive result in response to a drift phenomenon.

Methods are presented for drift detection and correction for predictive analytics. In one embodiment, a method includes generating one or more predictive results by applying a model to workload data. In certain embodiments, workload data may include one or more records. In further embodiments, a model may include one or more learned functions based on training data. In one embodiment, a method includes detecting a drift phenomenon relating to one or more predictive results. In a certain embodiment, a method includes retraining a model based on updated training data, in response to detecting a drift phenomenon.

Computer program products are presented for drift detection and correction for predictive analytics. In various embodiments, a computer program product includes a computer readable storage medium storing computer usable program code executable to perform operations. In certain embodiments, an operation includes applying a model to workload data to produce one or more predictive results. In further embodiments, workload data may include one or more records. In some embodiments, a model may include one or more learned functions based on training data. In a certain embodiment, an operation includes detecting a drift phenomenon relating to one or more predictive results. In a further embodiment, an operation includes modifying at least one predictive result in response to a drift phenomenon. In some embodiments, an operation includes retraining a model based on updated training data, in response to detecting a drift phenomenon.

### BRIEF DESCRIPTION OF THE DRAWINGS

In order that the advantages of the disclosure will be readily understood, a more particular description of the disclosure briefly described above will be rendered by reference to specific embodiments that are illustrated in the appended drawings. Understanding that these drawings depict only typical embodiments of the disclosure and are not therefore to be considered to be limiting of its scope, the disclosure will be described and explained with additional specificity and detail through the use of the accompanying drawings, in which:

FIG. 1 is a schematic block diagram illustrating one embodiment of a system for predictive analytics;

FIG. 2 is a schematic block diagram illustrating one embodiment of a predictive analytics module;

FIG. 3 is a schematic block diagram illustrating a further embodiment of a predictive analytics module;

FIG. 4 is a schematic block diagram illustrating one embodiment of a prediction module;

FIG. 5 is a schematic block diagram illustrating another embodiment of a prediction module;

FIG. 6 is a schematic block diagram illustrating one embodiment of a system for a predictive analytics factory;

FIG. 7 is a schematic block diagram illustrating one embodiment of learned functions for a predictive ensemble;

FIG. 8 is a schematic flow chart diagram illustrating one embodiment of a method for predictive drift detection and correction;

FIG. 9 is a schematic flow chart diagram illustrating another embodiment of a method for predictive drift detection and correction;

FIG. 10 is a schematic flow chart diagram illustrating one embodiment of a method for a predictive analytics factory;

FIG. 11 is a schematic flow chart diagram illustrating another embodiment of a method for a predictive analytics factory; and

FIG. 12 is a schematic flow chart diagram illustrating one embodiment of a method for directing data through a predictive ensemble.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

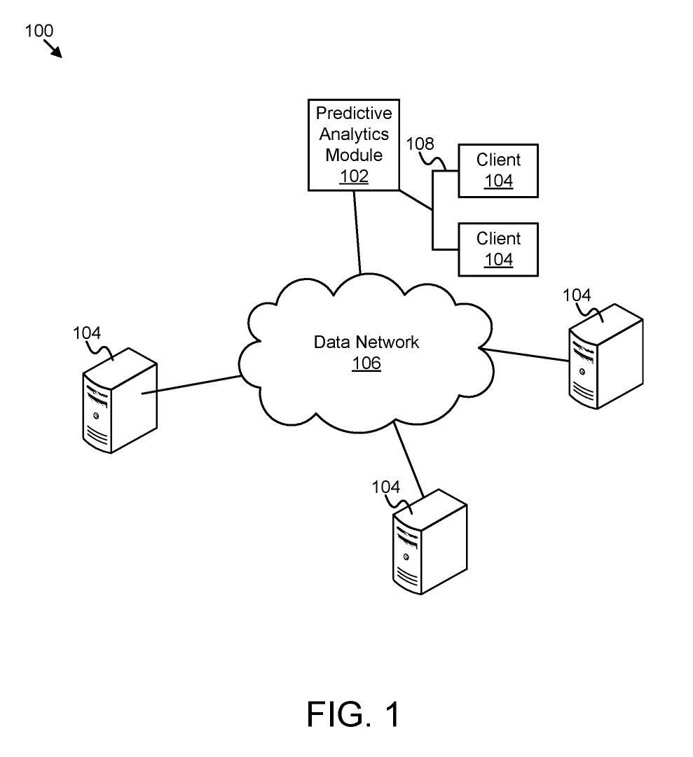

FIG. 1 depicts one embodiment of a system 100 for predictive analytics. The system 100, in the depicted embodiment, includes a predictive analytics module 102 that is in communication with several clients 104 over a data network 106, and with several clients 104 over a local channel 108, such as a system bus, an application programming interface (API), or the like. A client 104 may comprise a software application, a user, a hardware computing device with a processor and memory, or another entity in communication with the predictive analytics module 102. In general, the predictive analytics module 102 generates predictive results for the clients 104. In certain embodiments, the predictive analytics module 102 provides a predictive analytics framework allowing clients 104 to request predictive ensembles or other machine learning, to make analysis requests, and/or to receive predictive results, such as a classification, a confidence metric, an inferred function, a regression function, an answer, a prediction, a recognized pattern, a rule, a recommendation, or other results.

Predictive analytics is the study of past performance, or patterns, found in historical and transactional data to identify behavior and trends in future events. This may be accomplished using a variety of techniques including statistical modeling, machine learning, data mining, or the like.

One term for large, complex, historical data sets is Big Data. Examples of Big Data include web logs, social networks, blogs, system log files, call logs, customer data, user feedback, or the like. These data sets may often be so large and complex that they are awkward and difficult to work with using traditional tools. With technological advances in computing resources, including memory, storage, and computational power, along with frameworks and programming models for data-intensive distributed applications, the ability to collect, analyze and mine these huge repositories of structured, unstructured, and/or semi-structured data is now possible.

In certain embodiments, predictive models may be constructed to solve at least two general problem types: Regression and Classification. Regression and Classification problems may both be trained using supervised learning techniques. In supervised learning, predictive models are trained using sample historic data and associated historic outcomes. The models then make use of new data of the type used during training to predict outcomes.

Regression models may be trained using supervised learning to predict a continuous numeric outcome. These models may include Linear Regression, Support Vector Regression, K-Nearest Neighbors, Multivariate Adaptive Regression Splines, Regression Trees, Bagged Regression Trees, and Boosting, and the like.

Classification models may be trained using supervised learning to predict a categorical outcome, or class. Classification methods may include Neural Networks, Radial Basis Functions, Support Vector Machines, Naïve Bayes, k-Nearest Neighbors, Geospatial Predictive modeling, and the like.

Each of these forms of modeling makes assumptions about the data set and models the given data in a different way. Some models are more accurate than others, and which models are most accurate varies based on the data. Historically, using predictive analytics tools was a cumbersome and difficult process, often involving the engagement of a Data Scientist or other expert. Any easier-to-use tools or interfaces for general business users, however, typically fall short in that they still require “heavy lifting” by IT personnel in order to present and massage data and results. A Data Scientist typically must determine the optimal class of learning machines that would be the most applicable for a given data set, and rigorously test the selected hypothesis by first, fine-tuning the learning machine parameters, and second, evaluating results fed by trained data.

The predictive analytics module 102, in certain embodiments, generates predictive ensembles for the clients 104, with little or no input from a Data Scientist or other expert, by generating a large number of learned functions from multiple different classes, evaluating, combining, and/or extending the learned functions, synthesizing selected learned functions, and organizing the synthesized learned functions into a predictive ensemble. The predictive analytics module 102, in one embodiment, services analysis requests for the clients 104 using the generated predictive ensembles to produce predictive results.

By generating a large number of learned functions, without regard to the effectiveness of the generated learned functions, without prior knowledge of the generated learned functions suitability, or the like, and evaluating the generated learned functions, in certain embodiments, the predictive analytics module 102 may provide predictive ensembles that are customized and finely tuned for data from a specific client 104, without excessive intervention or fine-tuning. The predictive analytics module 102, in a further embodiment, may generate and evaluate a large number of learned functions using parallel computing on multiple processors, such as a massively parallel processing (MPP) system or the like.

The predictive analytics module 102 may service predictive analytics requests to clients 104 locally, executing on the same host computing device as the predictive analytics module 102, by providing an API to clients 104, receiving function calls from clients 104, providing a hardware command interface to clients 104, or otherwise providing a local channel 108 to clients 104. In a further embodiment, the predictive analytics module 102 may service predictive analytics requests to clients 104 over a data network 106, such as a local area network (LAN), a wide area network (WAN) such as the Internet as a cloud service, a wireless network, a wired network, or another data network 106.

In various embodiments, the predictive analytics module 102 may apply a model (e.g., a predictive ensemble, one or more learned functions or the like) to workload data to produce predictive results. Learned functions of the model may be based on training data. In certain embodiments, however, one or more drift phenomena may occur relating to predictive results. For example, input drift, or workload data drift, may occur when the workload data drifts from the input data. A data value, set of data values, average value, or other statistic in the workload data may be missing, or may be out of a range established by the training data, due to changing data gathering practices, a changing population that the workload data is gathered from. As another example, output drift may occur where a predictive result, a set of predictive results, statistic for a set of predictive results, or the like, is no longer consistent with actual (versus predicted) outcomes, outcomes in the training data, prior predictive results, or the like.

Therefore, in various embodiments, the predictive analytics module 102 may apply a predict-time fix that modifies one or more predictive results in response to a drift phenomenon. In certain embodiments, the predictive analytics module 102 may retrain a predictive model (e.g., generate a new/retrained predictive ensemble, generate new/retrained learned functions, or the like), in response to detecting the drift phenomenon.

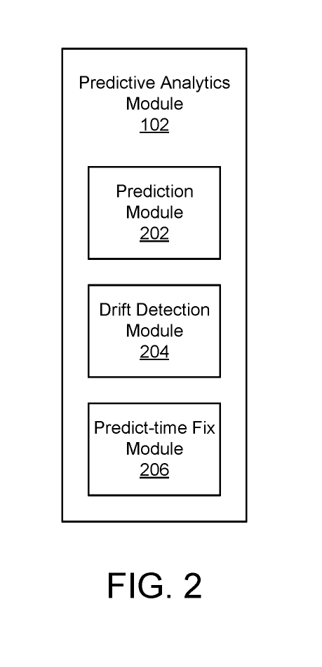

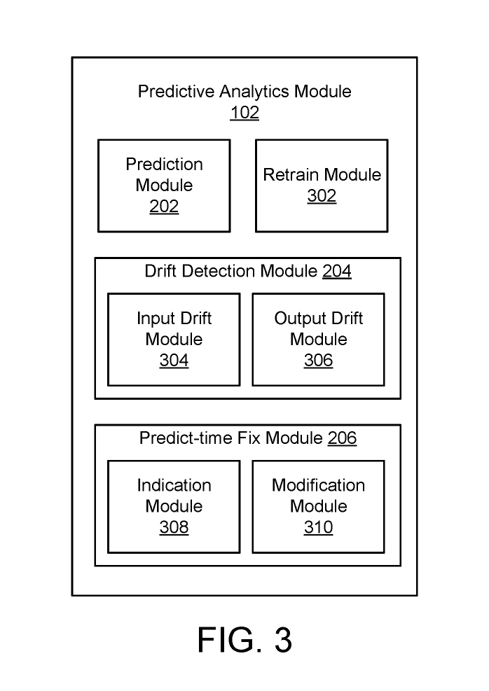

In general, in various embodiments, applying a predict-time fix and/or retraining a predictive model in response to one or more drift phenomena may allow the predictive analytics module 102 to compensate for input and/or output drift, and to provide predictive results that account for the drift. By contrast, a predictive analytics system that does not detect and/or correct drift may provide less accurate predictions to clients 104. A predictive analytics module 102 with drift detection and correction is described in further detail below with regard to FIGS. 2 and 3.

FIG. 2 is a schematic block diagram illustrating one embodiment of a predictive analytics module 102. The predictive analytics module 102 of FIG. 2, in certain embodiments, may be substantially similar to the predictive analytics module 102 described above with regard to FIG. 1. In the depicted embodiment, the predictive analytics module 102 includes a prediction module 202, a drift detection module 204, and a predict-time fix module 206.

The prediction module 202, in one embodiment, is configured to apply a model to workload data to produce one or more predictive results. The workload data, in certain embodiments, may include one or more records. If a further embodiment, the model may include one or more learned functions based on training data. The predictive results are generated by applying the model to the workload data.

In general, in various embodiments, predictive analytics involves generating a model based on training data, and applying the model to workload data to generate predictive results. For example, in one embodiment, predictive analytics for healthcare may use medical records for patients who are known to have (or to be free of) heart disease as training data to generate a model of what types of patients are likely to develop heart disease. The model may be applied to workload data, such as medical records for new patients, to predict a heart disease risk for the new patients. Various fields including healthcare, marketing, finance, and the like, in which training data may be useful for generating models, will be clear in view of this disclosure.

In various embodiment, workload data may refer to any data upon which a prediction or a predictive result may be based. For example, workload data may include medical records for healthcare predictive analytics, credit records for credit scoring predictive analytics, records of past occurrences of an event for predicting future occurrences of the event, or the like. In certain embodiments, workload data may include one or more records. In various embodiments, a record may refer to a discrete unit of one or more data values. For example, a record may be a row of a table in a database, a data structure including one or more data fields, or the like. In certain embodiments, a record may correspond to a person, organization, or event. For example, for healthcare predictive analytics, a record may be a patient's medical history, a set or one or more test results, or the like. Similarly, for marketing predictions, a record may be a set of data about a marketing campaign. Various types of records for predictive analytics will be clear in view of this disclosure.

In certain embodiments, records within training data may be similar to records within workload data. However, in a further embodiment, training data may include data that is not included in the workload data. For example, training data for marketing predictions may include results of previous campaigns (in terms of new customers, new revenue, or the like), that may be used to predict results for prospective new campaigns. Thus, in certain embodiments, training data may refer to historical data for which one or more results are known, and workload data may refer to present or prospective data for which one or more results are to be predicted.

A model, in various embodiments, may refer to any rule, function, algorithm, set of rules, functions, and/or algorithms, or the like that a prediction module 202 may apply to workload data to produce a predictive result. For example, a model may include a predictive ensemble, a learned function, a set of learned functions, or the like. A predictive result, in various embodiments, may include a classification or categorization, a ranking, a confidence metric, a score, an answer, a forecast, a recognized pattern, a rule, a recommendation, or any other type of prediction. For example, a predictive result for credit analysis may classify one customer as a good or bad credit risk, score the credit risk for a set of loans, rank possible transactions by predicted credit risk, provide a rule for future transactions, or the like. Various types of predictive results will be clear in view of this disclosure.

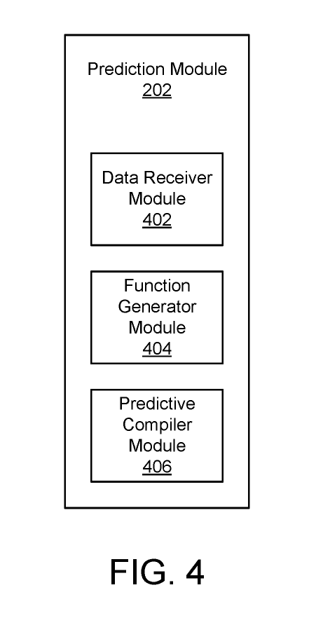

In certain embodiments, a model applied by the prediction module 202 to produce predictive results may include one or more learned functions based on training data. In general, a learned function may include a function that accepts an input (such as training data or workload data) and provides a result. In certain embodiments, the prediction module 202 may randomly or pseudo-randomly generate a plurality of learned functions, and may apply the learned functions thus generated to one or more subsets of the training data to select useful, suitable, and/or effective learned functions, or to further refine or combine the learned functions. The prediction module 202 may base the learned functions of the model on the training data by selecting learned functions for the model based on applying a plurality of learned functions to training or test data, determining parameters of learned functions for the model based on the training data, or the like. Various embodiments of a prediction module 202 generating and testing learned functions based on training data are described in further detail below with regard to FIGS. 4-7 and 10-12.

The drift detection module 204, in one embodiment, is configured to detect one or more drift phenomena relating to the one or more predictive results produced by the prediction module 202. In various embodiments, a drift phenomenon refers to a detectable change, or to a change that violates a threshold, in one or more inputs and/or output for a model. For example, an input drift or workload data drift phenomenon may include a change in workload data, in comparison to training data or past workload data. Similarly, an output drift phenomenon may include a change in predictive results from a model, relative to actual outcomes (included in the training data and/or obtained for past workload data) or relative to prior predictive results. Thus, an output drift phenomenon relates directly to the one or more predictive results produced by the prediction module 202, and an input drift phenomenon relates indirectly to the one or more predictive results produced by the prediction module 202, because the input drift phenomenon may affect the predictive results. Detection of input or workload data drift and output drift is described in further detail below with regard to the input drift module 304 and the output drift module 306 of FIG. 3.

In various embodiments, a drift phenomenon relating to one or more predictive results may affect one or more records. In one embodiment, a drift phenomenon may or pertain to a single record of workload data, or affect a single result. For example, if the training data establishes or suggests an expected range for a data value, the drift detection module 204 may detect an out-of-range value in a workload data record as a drift phenomenon. In another embodiment, however, a drift phenomenon may affect multiple records, or pertain to multiple results. For example, if the training data establishes or suggests an expected average for a data value in the workload data or in the predictive results, then the drift detection module 204 may detect a shift for the average value over time as a drift phenomenon, even if individual records or results corresponding to the shifted average are not out of range.

In certain embodiments, the drift detection module 204 may communicate with the prediction module 202. The drift detection module 204 may monitor one or more inputs (e.g., client data, initialization data, training data, test data, workload data, labeled data, unlabeled data, or the like) and/or outputs (e.g., predictions or other results) of the prediction module 202, to detect one or more changes (e.g., drifting) in the one or more inputs and/or outputs. For example, in certain embodiments, the drift detection module 204 may use machine learning and/or a statistical analysis of the one or more monitored inputs and/or outputs to detect and/or predict drift.

For example, one or more characteristics of a client 104's data may drift or change over time. In various embodiments, a client 104 may adjust the way it collects data (e.g., adding fields, removing fields, encoding the data differently, or the like), demographics may change over time, a client 104's locations and/or products may change, a technical problem may occur in calling a predictive model, or the like. Such changes in data may cause a predictive model (e.g., an ensemble or other machine learning) from the prediction module 202 to become less accurate over time, even if a model was initially accurate.

Drift and/or another change in an input or output of the prediction module 202 (e.g., of a predictive ensemble, one or more learned functions, or other machine learning), in certain embodiments, may comprise one or more values not previously detected for the input or output, not previously detected with a current frequency, or the like. For example, in various embodiments, the drift detection module 204 may determine whether a value for a monitored input and/or output is outside of a predefined range (e.g., a range defined based on training data for the input and/or output), whether a value is missing, whether a value is different than an expected value, whether a value satisfies at least a threshold difference from an expected and/or previous value, whether a ratio of values (e.g., male and female, yes and no, true and false, zip codes, area codes) varies from an expected and/or previous ratio, or the like.

The drift detection module 204, in certain embodiments, may perform a statistical analysis of one or more inputs and/or outputs (e.g., results) to determine drift. For example, the drift detection module 204 may compare a statistical distribution of outcomes from the prediction module 202 to a statistical distribution of initialization data (e.g., training data, testing data, or the like). The drift detection module 204 may compare outcomes from the prediction module 202 (e.g., machine learning predictions based on workload data) to outcomes identified in the evaluation metadata described below, in order to determine whether a drift phenomenon has occurred (e.g., an anomaly in the results, a ratio change in classifications, a shift in values of the results, or the like).

In certain embodiments, the drift detection module 204 may break up and/or group results from the prediction module 202 into classes or sets (e.g., by row, by value, by time, or the like) and may perform a statistical analysis of the classes or sets. For example, the drift detection module 204 may determine that a size and/or ratio of one or more classes or sets has changed and/or drifted over time, or the like. In one embodiment, the drift detection module 204 may monitor and/or analyze confidence metrics from the prediction module 202 to detect drift (e.g., if a distribution of confidence metrics becomes bimodal and/or exhibits a different change).

In one embodiment, the drift detection module 204 may use a binary classification (e.g., training or other initialization data labeled with a “0” and workload data labeled with a “1” or vice versa, data before a timestamp labeled with a “0” and data after the timestamp labeled with a “1” or vice versa, or another binary classification) and if the drift detection module 204 can tell the difference between the classes (e.g., using machine learning and/or a statistical analysis), a drift has occurred. The drift detection module 204 may perform a binary classification periodically overtime in response to a trigger (e.g., every N predictions, once a day, once a week, once a month, and/or another period). The drift detection module 204, in one embodiment, may determine a baseline variation in data by performing a binary classification on two different groups of training data, and may set a threshold for subsequent binary classifications based on the baseline (e.g., in response to detecting a 3% baseline variation, the drift detection module 204 may set a threshold for detecting drift higher than 3%, such as 4%, 5%, 10%, or the like).

In a further embodiment, the drift detection module 204 may track outcomes of one or more actions made based on results from a model, ensemble or other machine learning of the prediction module 202 to detect drift or other changes. For example, the drift detection module 204 may track payments made as loans mature, graduation rates of students over time, revenue, sales, and/or another outcome or metric, in order to determine if unexpected drift or changes have occurred. The drift detection module 204 may store one or more values for inputs and/or outputs, results, and/or outcomes or other metrics received from a client 104, in order to detect drift or other changes over time.

The predict-time fix module 206, in one embodiment, is configured to modify at least one predictive result from the prediction module 202 in response to the drift detection module 204 detecting a drift phenomenon. In one embodiment, the predict-time fix module 206 may modify a predictive result by changing one or more portions of the predictive result. For example, in one embodiment, the drift detection module 204 may detect an out-of-range value in the workload data, and the predict-time fix module 206 may modify a predictive result by reapplying the model of the prediction module 202 to modified workload data, in which the out-of-range value is omitted. In another embodiment, the predict-time fix module 206 may modify a predictive result by adding information to the predictive result. For example, in one embodiment, the predict-time fix module 206 may modify a predictive result to include an indicator or flag indicating that the drift detection module 204 detected a drift phenomenon. Various indicators that may be included or modifications that may be made by the predict-time fix module 206 are discussed in further detail below with regard to the indication module 308 and the modification module 310 of FIG. 3.

In one embodiment, a predictive analytics module 102 may omit a predict-time fix module 206. For example, in a certain embodiment, a predictive analytics module 102 may use a retrain module (e.g., the retrain module 302 of FIG. 3) to retrain a model for the prediction module 202, instead of applying a predict-time change or modification using the predict-time fix module 206. In another embodiment, a predictive analytics module 102 may use a predict-time fix module 206 and a retrain module. In various embodiments, a predict-time fix module 206 may modify a predictive result (e.g., by adding an indicator or changing a portion of the result) at or near the time of the prediction, (e.g., in connection with the prediction module 202 producing the result, sending the result to a client 104, or the like). Conversely, in further embodiments, a retrain module may modify the predictive model instead of modifying predictive results. Thus, in various embodiments, a predict-time fix module 206 and/or a retrain module may provide short-term and/or long-term drift correction, respectively.

In response to detecting a drift or other change, the predict-time fix module 206, in one embodiment, may notify a user or other client 104. For example, the predict-time fix module 206 may set a drift flag or other indicator in a response (e.g., with or without a prediction or other result); send a user a text, email, push notification, pop-up dialogue, and/or another message (e.g., within a graphical user interface (GUI) of the predictive analytics module 102 or the like); and/or may otherwise notify a user or other client 104 of a drift or other change. In certain embodiments, the predict-time fix module 206 may allow the prediction module 202 to provide a prediction or other result, despite a detected drift or other change (e.g., with or without a drift flag or other indicator as described above). In other embodiments, the predict-time fix module 206 may provide a drift flag or other indicator without a prediction or other result, preventing the prediction module 202 from making a prediction or providing another result (e.g., and providing an error comprising a drift flag or other indicator instead).

The predict-time fix module 206 may provide a drift flag or other indicator at a record granularity (e.g., indicating which record(s) include one or more drifted values), at a feature granularity (e.g., indicating which feature(s) include one or more drifted values), or the like. In certain embodiments, the predict-time fix module 206 provides a drift flag or other indicator indicating an importance and/or priority of the drifted record and/or feature (e.g., a ranking of the drifted record and/or feature relative to other records and/or features in order of importance or impact on a prediction or other result, an estimated or otherwise determined impact of the drifted record and/or feature on a prediction or other result, or the like).

The predict-time fix module 206, in one embodiment, provides a user or other client 104 with a drift summary comprising one or more drift statistics, such as a difference in one or more values over time, a score or other indicator of a severity of the drift or change, a ranking of the drifted record and/or feature relative to other records and/or features in order of importance or impact on a prediction or other result, an estimated or otherwise determined impact of the drifted record and/or feature on a prediction or other result, or the like. The predict-time fix module 206 may provide a drift summary and/or one or more drift statistics in a predefined location, such as in a footer of a result file or other data object, may include a pointer and/or address for a drift summary and/or one or more drift statistics in a result data packet or other data object, or the like.

In one embodiment, the predict-time fix module 206 and/or the predictive analytics module 102 may generate machine learning (e.g., one or more ensembles, learned functions, and/or other machine learning) configured to account for expected drift, configured for complete and/or partial retraining to account for drift, or the like. For example, in certain embodiments, at training time, the drift detection module 204 may detect one or more values that are missing from one or more records in the training data, and may include one or more thresholds for predictions based on the missing values (e.g., if 2% of records are missing a value for a feature in training data, the drift detection module 204 may include a rule that the feature is to be used in predictions if up to 3% of records are missing value for the feature, but the feature is to be ignored if greater than 3% of records are missing values for the feature, a user is to be alerted if greater than 10% of records are missing values for the feature, or the like). Different features may have different weights or different drift thresholds, or the like, allowing for greater drift for features with less impact on predictions than for features with greater impact on predictions, or the like. In certain embodiments, the orchestration module 520 may be configured to modify and/or adjust the routing of data to account for drift using an existing ensemble or other predictive program.

The predict-time fix module 206 may estimate or otherwise determine an impact of the missing features and/or records on the original machine learning and/or on the retrained machine learning, and may provide the impact to a user or other client 104. For example, the predict-time fix module 206 may make multiple predictions or other results using data in a normal and/or expected range, and compare the predictions or other results to those made without the data, to determine an impact of missing the data on the predictions or other results.

FIG. 3 is a schematic block diagram illustrating a further embodiment of a predictive analytics module 102. The predictive analytics module 102 of FIG. 3, in certain embodiments, may be substantially similar to the predictive analytics module 102 described above with regard to FIGS. 1 and 2. In the depicted embodiment, the predictive analytics module 102 includes a prediction module 202, a drift detection module 204, a predict-time fix module 206, and a retrain module 302. The prediction module 202, the drift detection module 204, and the predict-time fix module 206 may be substantially as described above with regard to FIG. 2. In the depicted embodiment, the drift detection module 204 further includes an input drift module 304 and an output drift module 306. In the depicted embodiment, the predict-time fix module 206 includes an indication module 308 and a modification module 310.

The retrain module 302, in one embodiment, is configured to retrain the model used by the prediction module 202 in response to the drift detection module detecting the drift phenomenon. In various embodiments, retraining a model may be substantially similar to creating or training a model, as described herein, and may include generating or modifying learned functions based on training data, applying the learned functions to test data withheld from the training data, evaluating the performance of learned functions in relation to the test data, and the like. Retraining a model may include replacing a model, updating learned functions within a model, replacing learned functions within a model, or the like. In certain embodiments, retraining a model based on updated training data may allow the model to reflect new or altered ways of gathering and/or coding data, new or expanding populations that generate training and workload data, or the like.

In certain embodiments, in response to the drift detection module 204 detecting drift or change in one or more values for an input and/or output of the prediction module 202, may automatically correct or attempt to correct the drift, by using the retrain module 302 to retrain machine learning (e.g., one or more ensembles or portions thereof, one or more learned functions, or the like as described below). In one embodiment, the retrain module 302 retrains a model using new training data obtained from a user. For example, in one embodiment, the retrain module 302 may request additional training data from a user or other client 104, in order to train a new ensemble or other machine learning. The retrain module 302 may provide an interface (e.g., a prompt, an upload element, or the like) within a GUI of the predictive analytics module 102, as part of or in response to an alert or other message notifying the user or other client 104 of the drift or other change and allowing the user or other client 104 to provide additional training data.

In a further embodiment, the retrain module 302 may retrain a new ensemble, portion thereof, or other machine learning using one or more outcomes received from a user or other client 104, as described above. The retrain module 302, in certain embodiments, may periodically request outcome data and/or training data from a user or other client 104 regardless of whether drift has occurred, so that the retrain module 302 may automatically retrain machine learning in response to the drift detection module 204 detecting drift, without additional input from the user or other client 104. In one embodiment, the retrain module 302 may have access to training data and/or outcome data for a user or other client 104, such as one or more databases, spreadsheets, files, or other data objects, and the retrain module 302 may retrain machine learning for the user or other client 104 in response to the drift detection module 204 detecting drift without further input from the user or other client 104, or the like.

In certain embodiments, the retrain module 302 may modify existing training data to produce the updated training data for retraining (e.g., without obtaining additional data from a user. The retrain module 302, in certain embodiments, may retrain one or more ensembles or other machine learning for a user or other client 104 without additional data from the user or other client 104, by excluding records and/or features for which values have drifted or otherwise changed. For example, the retrain module 302 may exclude an entire feature and/or record if one or more of its values (e.g., a predetermined threshold amount) have drifted, changed, and/or are missing; may just exclude the drifted, changed, and/or missing values; may estimate and/or impute different values for drifted, changed, and/or missing values (e.g., based on training data, based on previous workload data, or the like); may shift the drifted distribution of values into an expected range; or the like. The retrain module 302, in one embodiment, may use the prediction module 202 to create an ensemble or other machine learning to predict missing values in a manner that may be more accurate than imputation and/or excluding the missing values.

In some embodiments, the retrain module 302 may modify training data by removing a feature affected by the drift phenomenon from the training data. For example, in one embodiment, workload data may include a broader age range than training data, and the retrain module 302 may omit age data from the modified training data. In certain embodiments, the retrain module 302 may modify training data by selecting records in the training data that are consistent with the drift phenomenon. For example, in one embodiment, workload data may include a narrower age range than training data, and the retrain module 302 may retrain the model by reusing the portions of the training data that are consistent with the narrower range.

In certain embodiments, the retrain module 302 may use one or more retrained ensembles or other machine learning temporarily until a user or other client 104 provides the retrain module 302 with additional data (e.g., training data, outcome data) which the retrain module 302 may use (e.g., in cooperation with the prediction module 202) to retrain the one or more ensembles or other machine learning again with actual data, which may be more accurate.

The retrain module 302, in one embodiment, may retrain machine learning excluding one or more feature and retrain machine learning replacing drifted, changed, and/or missing values with expected values, comparing and/or evaluating predictions or other results from both and selecting the most accurate retrained machine learning for use, or the like.

The retrain module 302, in one embodiment, may provide an interface (e.g., a GUI, an API, a command line interface (CLI), a web service or TCP/IP interface, or the like) allowing a user or other client 104 to select an automated mode for the retrain module 302, in which the retrain module 302 will automatically self-heal drifted, changed, and/or missing values, by replacing the values with expected values, by retraining machine learning without the values or with replacement values, by retraining machine learning using alternate training data or outcome data, or the like.

In a further embodiment, the retrain module 302 may prompt a user or other client 104 with one or more options for repairing or healing detected drift. For example, in one embodiment, the retrain module 302 may prompt a user to select whether to use new training data or modified training data for retraining a model. In various embodiment, the retrain module 302 may prompt a user with options such as an option for uploading new training data and retraining machine learning, an option for using existing machine learning with replacement expected values in place of drifted values, retraining machine learning without drifted values, retraining machine learning with replacement expected values, retraining machine learning with held back training data in which the drifted values are also found, do nothing, and/or one or more other options selectable by the user or other client 104. In the prompt, the retrain module 302, in certain embodiments, may include instructions for the user or other client 104 on how to fix or repair the drifted, changed, and/or missing data (e.g., values should be within range M-N, values should be encoded with a specific encoding or format, values should be selected from a predefined group, values should follow a predefined definition, or the like), as determined by the retrain module 302. The retrain module 302 may display to a user or other client 104 an old/original distribution of values and a new/drifted distribution of values (e.g., side by side, overlaid, or the like), one or more histograms of old/original values and/or new/drifted values, display a problem or change in the data leaving it to the user to determine a repair, or the like.

The retrain module 302, in one embodiment, performs one or more tests on retrained machine learning, to determine whether predictions from the retrained machine learning are more accurate than from the original machine learning. For example, the retrain module 302 may perform A/B testing, using both the original machine learning and the retrained machine learning for a predefined period after retraining the machine learning, alternating between the two, randomly selecting one or the other, and/or providing predictions or other results from both the original model and the retrained model to a user or other client 104. The retrain module 302 may perform the testing for a predefined trial period, then may select the more accurate machine learning, may allow a user or other client 104 to select one of the original model and the retrained model, or the like for continued use.

In one embodiment, the drift detection module 204 uses the input drift module 304 to detect a drift phenomenon that includes input or workload data drift. In various embodiments, workload data drift may refer to any detectable change in workload data (or to a change that violates a threshold) relative to prior workload data and/or training data. In various embodiments, the input drift module 304 may monitor workload data of the prediction module 202, and compare the monitored workload data to prior workload data or training data to detect workload data drift.

In one embodiment, workload data drift may include a missing value in the workload data. In certain embodiments, a value or feature may refer to a portion of a record, such as a column within a row, a field within a data structure, or the like. A missing value may refer to a value, feature, or field, for which a record does not include data, includes a placeholder value equivalent to no data (e.g., an age of −1), or the like. In one embodiment, the input drift module 304 may identify a single missing value as a drift phenomenon. For example, if the prediction module 202 predicts a patient's likelihood of heart disease using a model sensitive to age, than the input drift module 304 may detect a missing value in the “age” field for a single patient as a drift phenomenon, and the predict-time fix module 206 may apply a predict-time fix. In another embodiment, the input drift module 304 may identify an increased frequency of missing values as a drift phenomenon. For example, if the prediction module 202 predicts marketing results, than an increase in missing age data for customers may suggest a shifting (or aging) customer population, and the predict-time fix module 206 may apply a predict-time fix.

In a certain embodiment, workload data drift may include a value in the workload data that is out of a range established by the training data. A range established by the training data may refer to any measurement corresponding to a range or interval for a feature in the training data, or to a single end of a range or interval (which may or may not be open-ended), such as a minimum value, a maximum value, a difference between minimum and maximum values for a feature in the training data, an interquartile range, a standard deviation, a variance, or the like. For example, in one embodiment, the input drift module 304 may identify a value that is more than a certain number of standard deviations away from a mean established by the training data as out of range. In another embodiment, the input drift module may identify a set of values that exceed a maximum value in the training data as out of range.

In a certain embodiment, workload data drift may refer to a value that violates a threshold based on the training data, or to a statistic that violates a threshold based on the training data, where the statistic is based on a set of values in a plurality of records. For example, in various embodiments, the input drift module 304 may establish a threshold such as a minimum value, a maximum value, a range that an average is expected to be in, or the like, based on analyzing the training data, and may detect a drift phenomenon when a value, or a statistic for a set of values, violates the threshold. A statistic that violates a threshold may include any statistic or measurement based on a set of values in a plurality of workload records. For example, a statistic may include a range between minimum and maximum workload values, a standard deviation for workload data values, a ratio of true to false responses, a ratio of male to female respondents, a percentage of missing values, or the like and a threshold for the statistic may be violated if the statistic for the workload data differs from the corresponding statistic for the training data, or for past workload data by an absolute threshold difference, a threshold percentage value, or the like.

In one embodiment, the drift detection module 204 uses the output drift module 306 to detect a drift phenomenon that includes output drift in the one or more predictive results from the prediction module 202. In various embodiments, output drift may refer to any detectable change in predictive results (or to a change that violates a threshold) relative to prior predictive results, actual outcomes in the training data, and/or actual outcomes corresponding to one or more predictive results. In various embodiment, an outcome may refer to an actual or measured data value (or set of values), corresponding to a predicted data value (or set of values) in a predictive result. For example, in one embodiment, training data may include outcomes, so that the prediction module 202 can use a model that predicts unknown or future outcomes based on the known outcomes in the training data. In a certain embodiment, a user or client 104 may submit further outcomes (e.g., in addition to the outcomes in the training data) to the predictive analytics module 102, for ongoing evaluation of the accuracy of a predictive model.

In one embodiment, the output drift module 306 may detect output drift based on a predictive result from the prediction module violating a threshold. For example, a value for a result may be out of an expected range for results. In another embodiment, the output drift module 306 may detect output drift based on a statistic for a set of predictive results, where the statistic violates a threshold. A statistic that violates a threshold may include any statistic or measurement based on predicted results or actual outcomes. For example, a statistic such as a ratio of results, a distribution of results, or the like may violate a threshold based on ratio or distribution of results in prior predictions, a ratio or distribution of actual outcomes, or the like.

In one embodiment, the predict-time fix module 206 uses an indication module 308 to modify at least one predictive result from the prediction module 202, so that the modified predictive result(s) include an indicator of the drift phenomenon detected by the drift detection module 204. In various embodiments, an indicator may refer to any data value included with one or more predictive results that indicates that a drift phenomenon has been detected. For example, in one embodiment, an indicator may be a simple binary flag, indicating that one or more results may be less accurate due to drift. In another embodiment, an indicator may include data about the drift that was detected. In various embodiments, the indication module 308 may modify at least one predictive result to include an indicator of a drift phenomenon by including a flag, a description of the drift phenomenon, a link to a description of the drift phenomenon, or the like. In certain embodiments, the indication module 308 may include an indicator of a drift phenomenon in any format in which a predictive result may be presented, such as via email, via a GUI for the predictive analytics module 102, by including the indicator in tabular or serialized data (e.g., a CSV file or JSON object), or the like.

In one embodiment, an indicator included in a predictive result by the indication module 308 may identify a record in the workdata and/or a predictive result to which the drift phenomenon pertains. For example, where the drift detection module detects input or output drift pertaining to a single record or result, the indication module 308 may flag the pertinent result (or the corresponding record). In certain embodiments, indicating drift at a record-level granularity may suggest to a user or client 104 that unflagged predictive results are not affected by the drift phenomenon.

In a certain embodiment, an indicator included in a predictive result by the indication module 308 may identify a feature (e.g., a field of a record, a column of a table, or the like) to which the drift phenomenon relates, for a plurality of workload data records corresponding to a plurality of the predictive results. In some embodiments, training data may reflect outcomes for one population or demographic, and workload data may reflect a shifting population or demographic. For example, if a healthcare analytics module was trained on data from a student clinic, application of the model to a broader population may be detected by increased patient ages in the workload data. In another embodiment, drift affecting a feature may indicate changes in how a client 104 gathers or processes data. For example, if training data uses a scale from one to five to quantify some feature, and a user submits workload data quantifying the same feature on a different scale, from one to three, than the drift detection module 204 may detect the changed scale by the persistent absence of “four” or “five” values in the workload data. In certain embodiments, where the drift detection module 204 detects drift in a feature (such as patient age in the above example) for multiple records, the indication module 308 may flag the affected feature instead of (or in addition to) flagging individual records or results. In certain embodiments, indicating drift at a feature-level granularity may indicate to a user or client 104 where the client's population or data-gathering practices may have shifted.

In some embodiments, the indicator may provide instructions to a user for responding to a drift phenomenon. In certain embodiments, the indication module 308 may provide instructions by including the instructions with predictive results, including a link to instructions, or the like. In one embodiment, instructions may relate to changing workload data to satisfy a drift detection threshold relating to the training data. For example, if the drift detection module 204 determines that drift may be related to a client rescaling or otherwise differently collecting or classifying data, the indication module 308 may instruct a user to switch back to a scale or classification used in the training data. In another embodiment, if the drift detection module 204 determines that drift may be related to a shifted population, the indication module 308 may provide instructions for retraining the model. In one embodiment, the drift detection module 204 may determine that a drift phenomenon has occurred without identifying a likely source of the drift, and the indication module 308 may provide alternate instructions for changing the workload data and/or for retraining the model.

In one embodiment, the indicator included in a predictive result by the indication module 308 may include a comparison of data values in the workload data to a prior set of data values. In various embodiments, a prior set of data values may include data values from training data, prior workload data or the like. A comparison may include a numeric or textual comparison, a graphical comparison, or the like. For example, in one embodiment, a value in the workload data may be out of a range established by the training data, and the indicator may provide a comparison by providing the out-of-range value and the expected range, a distance between the out-of-range value and the range, or the like. In another embodiment, a value for a feature may have drifted in multiple workload records, and the indication module 308 may display a distribution or histogram for the drifted feature adjacent to or overlaid with a distribution or histogram for that feature in the training data and/or prior workload data.

In a certain embodiment, an indicator included in a predictive result by the indication module 308 may include a ranking of a feature affected by the drift phenomenon, based on the feature's significance in the model relative to at least one feature of the workload data other than the feature affected by the drift phenomenon. In some embodiments, various features (e.g., data fields or columns) of the workload data may be more or less significant than other features in a model. A feature's significance in a model may refer to any measurement or indication of the extent to which a predictive result made using the model changes when the feature changes in the workload data. For example, if a model for a healthcare risk returns a significantly different result when the age of a patient is changed, but a less significantly different result when the gender of the patient is changed, than age is a more significant feature in the model than gender. A ranking of a feature's significance relative to at least one other feature may include a list of multiple features in order of significance, a comparison of significance between two features, or the like. Various ways of determining and ranking the significance of features will be clear in view of this disclosure.

In certain embodiments, the indication module 308 including a ranking of a feature's relative significance may inform a user's decision as to whether to use a possibly inaccurate predictive result, use a modified predictive result, retrain the model, or the like. For example, a user may discard a result where a more significant feature of the workload data is missing or out of range, but may risk using a result where a less significant feature is missing or out of range.

In one embodiment, the predict-time fix module 206 uses a modification module 310 to modify one or more predictive results by including one or more updated results. In general, in various embodiments, the indication module 308 may report on the drift and/or how to fix it, and the modification module 310 may cooperate with the prediction module 202 to fix a predictive result by reapplying the model to modified workload data.

In certain embodiments, the modification module 310 may modify workload data for reapplying a predictive model in a variety of ways. In one embodiment, the modified workload data may include the original workload data with one or more data values removed. For example, where a data value in a record is out of a range established by the training data, the modification module may remove the out-of-range value from the modified data. Similarly, where the drift detection module 204 detects drift for a feature affecting multiple records, the modification module 310 may remove that feature from the modified workload data. For example, if an age range in the workload data is inconsistent with an age range in the training data, the modification module 310 may modify the workload data by removing out-of-range age values, or by removing all age values.

In a further embodiment, the modified workload data may include the original workload data with one or more data values replaced by imputed data values. For example, in one embodiment, a pattern may exist for missing data, and the modification module 310 may use a separate predictive model to generate likely values for the missing data. In another embodiment, the modification module 310 may shift or rescale data values in workload data to be consistent with training data. For example, if drift was caused by a user submitting data on a one to five scale instead of on a one to three scale, than rescaling the data may correct the drift. In another embodiment, the modification module 310 may use multiple imputation to modify the workload data, by generating multiple sets of modified workload data with various data values and pooling (e.g., averaging) the corresponding predictive results. In a certain embodiment, the modification module 310 may modify the workload data by replacing the original workload data with replacement data provided by a user or client 104. For example, in one embodiment, the modification module 310 may request that a user modify and reupload data (e.g., by reverting to an old scale for a data value). Various ways of modifying data for reapplying a predictive model will be clear in view of this disclosure.

In one embodiment, the modification module 310 may provide a modified predictive result based on reapplying a model to modified workload data, where the modified predictive result includes a comparison between an updated result and a corresponding non-updated result. For example, if the workload data is modified by omitting, rescaling, predicting, or otherwise imputing a data value, the modification module may show the original result and the modified result side by side, prompt the user to select which result is preferred, provide a measurement of the difference between the modified and unmodified results, or the like. In various embodiments, comparing updated and non-updated results may allow a user to determine if the difference in results justifies retraining the model, gathering additional data, or the like.

FIG. 4 depicts one embodiment of a prediction module 202. The prediction module 202 of FIG. 4, in certain embodiments, may be substantially similar to the prediction module 202 described above with regard to FIGS. 2 and 3. In the depicted embodiment, the prediction module 202 includes a data receiver module 402, a function generator module 404, and a predictive compiler module 406.

The data receiver module 402, in certain embodiments, is configured to receive client data, such as training data, test data, workload data, or the like, from a client 104, either directly or indirectly. The data receiver module 402, in various embodiments, may receive data over a local channel 108 such as an API, a shared library, a hardware command interface, or the like; over a data network 106 such as wired or wireless LAN, WAN, the Internet, a serial connection, a parallel connection, or the like. In certain embodiments, the data receiver module 402 may receive data indirectly from a client 104 through an intermediate module that may pre-process, reformat, or otherwise prepare the data for the predictive analysis module 102. The data receiver module 402 may support structured data, unstructured data, semi-structured data, or the like.

One type of data that the data receiver module 402 may receive, as part of a new ensemble request or the like, is initialization data. The prediction module 202, in certain embodiments, may use initialization data to train and test learned functions from which the prediction module 202 may build a predictive ensemble. Initialization data may comprise historical data, statistics, Big Data, customer data, marketing data, computer system logs, computer application logs, data networking logs, or other data that a client 104 provides to the data receiver module 402 with which to build, initialize, train, and/or test a predictive ensemble. In one embodiment, initialization data may comprise labeled data. In a further embodiment, initialization data may comprise unlabeled data (e.g., for semi-supervised learning or the like).

Another type of data that the data receiver module 402 may receive, as part of an analysis request or the like, is workload data. The prediction module 202, in certain embodiments, may process workload data using a predictive ensemble to obtain a result, such as a classification, a confidence metric, an inferred function, a regression function, an answer, a prediction, a recognized pattern, a rule, a recommendation, or the like. Workload data for a specific predictive ensemble, in one embodiment, has substantially the same format as the initialization data used to train and/or evaluate the predictive ensemble (e.g., labeled data, unlabeled data, or the like). For example, initialization data and/or workload data may include one or more features. As used herein, a feature may comprise a column, category, data type, attribute, characteristic, label, or other grouping of data. For example, in embodiments where initialization data and/or workload data that is organized in a table format, a column of data may be a feature. Initialization data and/or workload data may include one or more instances of the associated features. In a table format, where columns of data are associated with features, a row of data is an instance. In other embodiments, initialization data and/or workload data may be labeled (e.g., may already include predictions, in order to validate and/or detect drift in another machine learning model, or the like).

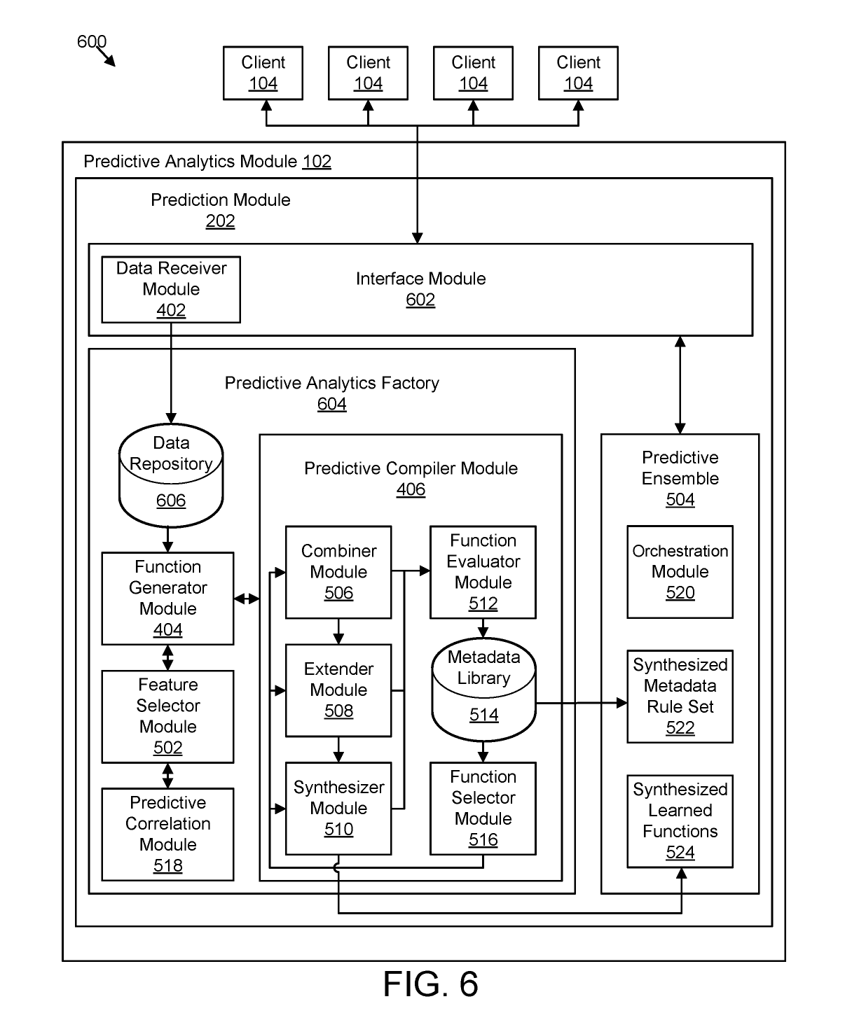

As described below with regard to FIG. 6, in one embodiment, the data receiver module 402 may maintain client data, such as initialization data and/or workload data, in a data repository 606, where the function generator module 404, the predictive compiler module 406, or the like may access the data. In certain embodiments, as described below, the function generator module 404 and/or the predictive compiler module 406 may divide initialization data into subsets, using certain subsets of data as training data for generating and training learned functions and using certain subsets of data as test data for evaluating generated learned functions.

The function generator module 404, in certain embodiments, is configured to generate a plurality of learned functions based on training data from the data receiver module 402. A learned function, as used herein, comprises a computer readable code that accepts an input and provides a result. A learned function may comprise a compiled code, a script, text, a data structure, a file, a function, or the like. In certain embodiments, a learned function may accept instances of one or more features as input, and provide a result, such as a classification, a confidence metric, an inferred function, a regression function, an answer, a prediction, a recognized pattern, a rule, a recommendation, or the like. In another embodiment, certain learned functions may accept instances of one or more features as input, and provide a subset of the instances, a subset of the one or more features, or the like as an output. In a further embodiment, certain learned functions may receive the output or result of one or more other learned functions as input, such as a Bayes classifier, a Boltzmann machine, or the like.

The function generator module 404 may generate learned functions from multiple different predictive analytics classes, models, or algorithms. For example, the function generator module 404 may generate decision trees; decision forests; kernel classifiers and regression machines with a plurality of reproducing kernels; non-kernel regression and classification machines such as logistic, CART, multi-layer neural nets with various topologies; Bayesian-type classifiers such as Naïve Bayes and Boltzmann machines; logistic regression; multinomial logistic regression; probit regression; AR; MA; ARMA; ARCH; GARCH; VAR; survival or duration analysis; MARS; radial basis functions; support vector machines; k-nearest neighbors; geospatial predictive modeling; and/or other classes of learned functions.

In one embodiment, the function generator module 404 generates learned functions pseudo-randomly, without regard to the effectiveness of the generated learned functions, without prior knowledge regarding the suitability of the generated learned functions for the associated training data, or the like. For example, the function generator module 404 may generate a total number of learned functions that is large enough that at least a subset of the generated learned functions are statistically likely to be effective. As used herein, pseudo-randomly indicates that the function generator module 404 is configured to generate learned functions in an automated manner, without input or selection of learned functions, predictive analytics classes or models for the learned functions, or the like by a Data Scientist, expert, or other user.

The function generator module 404, in certain embodiments, generates as many learned functions as possible for a requested predictive ensemble, given one or more parameters or limitations. A client 104 may provide a parameter or limitation for learned function generation as part of a new ensemble request or the like to an interface module 602 as described below with regard to FIG. 6, such as an amount of time; an allocation of system resources such as a number of processor nodes or cores, or an amount of volatile memory; a number of learned functions; runtime constraints on the requested ensemble such as an indicator of whether or not the requested ensemble should provide results in real-time; and/or another parameter or limitation from a client 104.

The number of learned functions that the function generator module 404 may generate for building a predictive ensemble may also be limited by capabilities of the system 100, such as a number of available processors or processor cores, a current load on the system 100, a price of remote processing resources over the data network 106; or other hardware capabilities of the system 100 available to the function generator module 404. The function generator module 404 may balance the hardware capabilities of the system 100 with an amount of time available for generating learned functions and building a predictive ensemble to determine how many learned functions to generate for the predictive ensemble.

In one embodiment, the function generator module 404 may generate at least 50 learned functions for a predictive ensemble. In a further embodiment, the function generator module 404 may generate hundreds, thousands, or millions of learned functions, or more, for a predictive ensemble. By generating an unusually large number of learned functions from different classes without regard to the suitability or effectiveness of the generated learned functions for training data, in certain embodiments, the function generator module 404 ensures that at least a subset of the generated learned functions, either individually or in combination, are useful, suitable, and/or effective for the training data without careful curation and fine tuning by a Data Scientist or other expert.

Similarly, by generating learned functions from different predictive analytics classes without regard to the effectiveness or the suitability of the different predictive analytics classes for training data, the function generator module 404, in certain embodiments, may generate learned functions that are useful, suitable, and/or effective for the training data due to the sheer amount of learned functions generated from the different predictive analytics classes. This brute force, trial-and-error approach to generating learned functions, in certain embodiments, eliminates or minimizes the role of a Data Scientist or other expert in generation of a predictive ensemble.

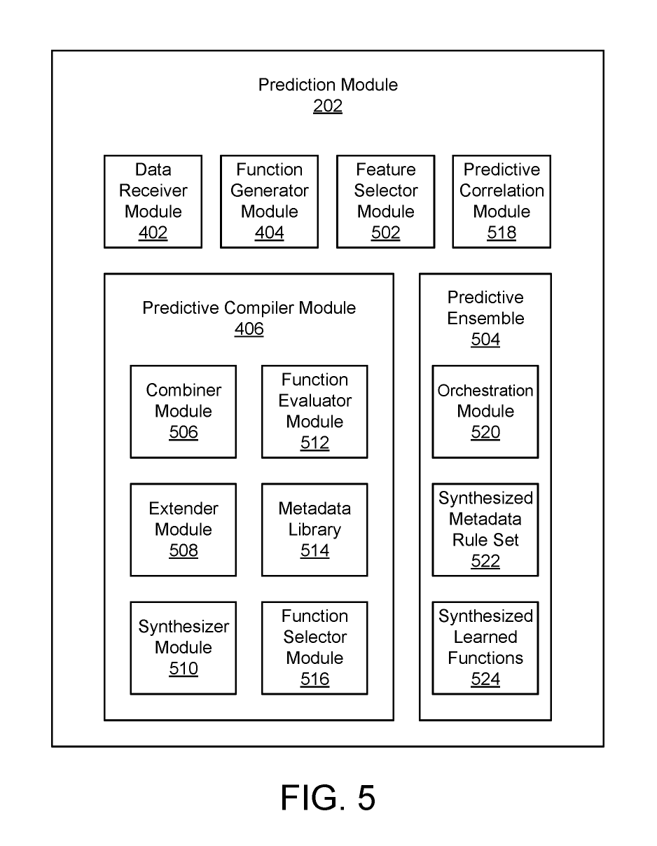

The function generator module 404, in certain embodiments, divides initialization data from the data receiver module 402 into various subsets of training data, and may use different training data subsets, different combinations of multiple training data subsets, or the like to generate different learned functions. The function generator module 404 may divide the initialization data into training data subsets by feature, by instance, or both. For example, a training data subset may comprise a subset of features of initialization data, a subset of features of initialization data, a subset of both features and instances of initialization data, or the like. Varying the features and/or instances used to train different learned functions, in certain embodiments, may further increase the likelihood that at least a subset of the generated learned functions are useful, suitable, and/or effective. In a further embodiment, the function generator module 404 ensures that the available initialization data is not used in its entirety as training data for any one learned function, so that at least a portion of the initialization data is available for each learned function as test data, which is described in greater detail below with regard to the function evaluator module 512 of FIG. 5.

In one embodiment, the function generator module 404 may also generate additional learned functions in cooperation with the predictive compiler module 406. The function generator module 404 may provide a learned function request interface, allowing the predictive compiler module 406 or another module, a client 104, or the like to send a learned function request to the function generator module 404 requesting that the function generator module 404 generate one or more additional learned functions. In one embodiment, a learned function request may include one or more attributes for the requested one or more learned functions. For example, a learned function request, in various embodiments, may include a predictive analytics class for a requested learned function, one or more features for a requested learned function, instances from initialization data to use as training data for a requested learned function, runtime constraints on a requested learned function, or the like. In another embodiment, a learned function request may identify initialization data, training data, or the like for one or more requested learned functions and the function generator module 404 may generate the one or more learned functions pseudo-randomly, as described above, based on the identified data.

The predictive compiler module 406, in one embodiment, is configured to form a predictive ensemble using learned functions from the function generator module 404. As used herein, a predictive ensemble comprises an organized set of a plurality of learned functions. Providing a classification, a confidence metric, an inferred function, a regression function, an answer, a prediction, a recognized pattern, a rule, a recommendation, or another result using a predictive ensemble, in certain embodiments, may be more accurate than using a single learned function.

The predictive compiler module 406 is described in greater detail below with regard to FIG. 5. The predictive compiler module 406, in certain embodiments, may combine and/or extend learned functions to form new learned functions, may request additional learned functions from the function generator module 404, or the like for inclusion in a predictive ensemble. In one embodiment, the predictive compiler module 406 evaluates learned functions from the function generator module 404 using test data to generate evaluation metadata. The predictive compiler module 406, in a further embodiment, may evaluate combined learned functions, extended learned functions, combined-extended learned functions, additional learned functions, or the like using test data to generate evaluation metadata.

The predictive compiler module 406, in certain embodiments, maintains evaluation metadata in a metadata library 514, as described below with regard to FIGS. 5 and 6. The predictive compiler module 406 may select learned functions (e.g. learned functions from the function generator module 404, combined learned functions, extended learned functions, learned functions from different predictive analytics classes, and/or combined-extended learned functions) for inclusion in a predictive ensemble based on the evaluation metadata. In a further embodiment, the predictive compiler module 406 may synthesize the selected learned functions into a final, synthesized function or function set for a predictive ensemble based on evaluation metadata. The predictive compiler module 406, in another embodiment, may include synthesized evaluation metadata in a predictive ensemble for directing data through the predictive ensemble or the like.

FIG. 5 depicts another embodiment of a prediction module 202. The prediction module 202 of FIG. 5, in certain embodiments, may be substantially similar to the prediction module 202 described above with regard to FIGS. 2, 3, and 4. In the depicted embodiment, the prediction module 202 includes the data receiver module 402, the function generator module 404, and the predictive compiler module 406 described above with regard to FIG. 4 and further includes a feature selector module 502 a predictive correlation module 518, and a predictive ensemble 504. The predictive compiler module 406, in the depicted embodiment, includes a combiner module 506, an extender module 508, a synthesizer module 510, a function evaluator module 512, a metadata library 514, and a function selector module 516. The predictive ensemble 504, in the depicted embodiment, includes an orchestration module 520, a synthesized metadata rule set 522, and synthesized learned functions 524.

In one embodiment, the feature selector module 502 determines which features of initialization data to use in the predictive ensemble 504, and in the associated learned functions, and/or which features of the initialization data to exclude from the predictive ensemble 504, and from the associated learned functions. As described above, initialization data, and the training data and test data derived from the initialization data, may include one or more features. Learned functions and the predictive ensembles 504 that they form are configured to receive and process instances of one or more features. Certain features may be more predictive than others, and the more features that the predictive compiler module 406 processes and includes in the generated predictive ensemble 504, the more processing overhead used by the predictive compiler module 406, and the more complex the generated predictive ensemble 504 becomes. Additionally, certain features may not contribute to the effectiveness or accuracy of the results from a predictive ensemble 504, but may simply add noise to the results.

The feature selector module 502, in one embodiment, cooperates with the function generator module 404 and the predictive compiler module 406 to evaluate the effectiveness of various features, based on evaluation metadata from the metadata library 514 described below. For example, the function generator module 404 may generate a plurality of learned functions for various combinations of features, and the predictive compiler module 406 may evaluate the learned functions and generate evaluation metadata. Based on the evaluation metadata, the feature selector module 502 may select a subset of features that are most accurate or effective, and the predictive compiler module 406 may use learned functions that utilize the selected features to build the predictive ensemble 504. The feature selector module 502 may select features for use in the predictive ensemble 504 based on evaluation metadata for learned functions from the function generator module 404, combined learned functions from the combiner module 506, extended learned functions from the extender module 508, combined extended functions, synthesized learned functions from the synthesizer module 510, or the like.

In a further embodiment, the feature selector module 502 may cooperate with the predictive compiler module 406 to build a plurality of different predictive ensembles 504 for the same initialization data or training data, each different predictive ensemble 504 utilizing different features of the initialization data or training data. The predictive compiler module 406 may evaluate each different predictive ensemble 504, using the function evaluator module 512 described below, and the feature selector module 502 may select the predictive ensemble 504 and the associated features which are most accurate or effective based on the evaluation metadata for the different predictive ensembles 504. In certain embodiments, the predictive compiler module 406 may generate tens, hundreds, thousands, millions, or more different predictive ensembles 504 so that the feature selector module 502 may select an optimal set of features (e.g. the most accurate, most effective, or the like) with little or no input from a Data Scientist, expert, or other user in the selection process.

In one embodiment, the predictive compiler module 406 may generate a predictive ensemble 504 for each possible combination of features from which the feature selector module 502 may select. In a further embodiment, the predictive compiler module 406 may begin generating predictive ensembles 504 with a minimal number of features, and may iteratively increase the number of features used to generate predictive ensembles 504 until an increase in effectiveness or usefulness of the results of the generated predictive ensembles 504 fails to satisfy a feature effectiveness threshold. By increasing the number of features until the increases stop being effective, in certain embodiments, the predictive compiler module 406 may determine a minimum effective set of features for use in a predictive ensemble 504, so that generation and use of the predictive ensemble 504 is both effective and efficient. The feature effectiveness threshold may be predetermined or hard coded, may be selected by a client 104 as part of a new ensemble request or the like, may be based on one or more parameters or limitations, or the like.

During the iterative process, in certain embodiments, once the feature selector module 502 determines that a feature is merely introducing noise, the predictive compiler module 406 excludes the feature from future iterations, and from the predictive ensemble 504. In one embodiment, a client 104 may identify one or more features as required for the predictive ensemble 504, in a new ensemble request or the like. The feature selector module 502 may include the required features in the predictive ensemble 504, and select one or more of the remaining optional features for inclusion in the predictive ensemble 504 with the required features.

In a further embodiment, based on evaluation metadata from the metadata library 514, the feature selector module 502 determines which features from initialization data and/or training data are adding noise, are not predictive, are the least effective, or the like, and excludes the features from the predictive ensemble 504. In other embodiments, the feature selector module 502 may determine which features enhance the quality of results, increase effectiveness, or the like, and selects the features for the predictive ensemble 504.

In one embodiment, the feature selector module 502 causes the predictive compiler module 406 to repeat generating, combining, extending, and/or evaluating learned functions while iterating through permutations of feature sets. At each iteration, the function evaluator module 512 may determine an overall effectiveness of the learned functions in aggregate for the current iteration's selected combination of features. Once the feature selector module 502 identifies a feature as noise introducing, the feature selector module may exclude the noisy feature and the predictive compiler module 406 may generate a predictive ensemble 504 without the excluded feature. In one embodiment, the predictive correlation module 518 determines one or more features, instances of features, or the like that correlate with higher confidence metrics (e.g., that are most effective in predicting results with high confidence). The predictive correlation module 518 may cooperate with, be integrated with, or otherwise work in concert with the feature selector module 502 to determine one or more features, instances of features, or the like that correlate with higher confidence metrics. For example, as the feature selector module 502 causes the predictive compiler module 406 to generate and evaluate learned functions with different sets of features, the predictive correlation module 518 may determine which features and/or instances of features correlate with higher confidence metrics, are most effective, or the like based on metadata from the metadata library 514.

The predictive correlation module 518, in certain embodiments, is configured to harvest metadata regarding which features correlate to higher confidence metrics, to determine which feature was predictive of which outcome or result, or the like. In one embodiment, the predictive correlation module 518 determines the relationship of a feature's predictive qualities for a specific outcome or result based on each instance of a particular feature. In other embodiments, the predictive correlation module 518 may determine the relationship of a feature's predictive qualities based on a subset of instances of a particular feature. For example, the predictive correlation module 518 may discover a correlation between one or more features and the confidence metric of a predicted result by attempting different combinations of features and subsets of instances within an individual feature's dataset, and measuring an overall impact on predictive quality, accuracy, confidence, or the like. The predictive correlation module 518 may determine predictive features at various granularities, such as per feature, per subset of features, per instance, or the like.

In one embodiment, the predictive correlation module 518 determines one or more features with a greatest contribution to a predicted result or confidence metric as the predictive compiler module 406 forms the predictive ensemble 504, based on evaluation metadata from the metadata library 514, or the like. For example, the predictive compiler module 406 may build one or more synthesized learned functions 524 that are configured to provide one or more features with a greatest contribution as part of a result. In another embodiment, the predictive correlation module 518 may determine one or more features with a greatest contribution to a predicted result or confidence metric dynamically at runtime as the predictive ensemble 504 determines the predicted result or confidence metric. In such embodiments, the predictive correlation module 518 may be part of, integrated with, or in communication with the predictive ensemble 504. The predictive correlation module 518 may cooperate with the predictive ensemble 504, such that the predictive ensemble 504 provides a listing of one or more features that provided a greatest contribution to a predicted result or confidence metric as part of a response to an analysis request.

In determining features that are predictive, or that have a greatest contribution to a predicted result or confidence metric, the predictive correlation module 518 may balance a frequency of the contribution of a feature and/or an impact of the contribution of the feature. For example, a certain feature or set of features may contribute to the predicted result or confidence metric frequently, for each instance or the like, but have a low impact. Another feature or set of features may contribute relatively infrequently, but has a very high impact on the predicted result or confidence metric (e.g. provides at or near 100% confidence or the like). While the predictive correlation module 518 is described herein as determining features that are predictive or that have a greatest contribution, in other embodiments, the predictive correlation module 518 may determine one or more specific instances of a feature that are predictive, have a greatest contribution to a predicted result or confidence metric, or the like.

In the depicted embodiment, the predictive compiler module 406 includes a combiner module 506. The combiner module 506 combines learned functions, forming sets, strings, groups, trees, or clusters of combined learned functions. In certain embodiments, the combiner module 506 combines learned functions into a prescribed order, and different orders of learned functions may have different inputs, produce different results, or the like. The combiner module 506 may combine learned functions in different combinations. For example, the combiner module 506 may combine certain learned functions horizontally or in parallel, joined at the inputs and at the outputs or the like, and may combine certain learned functions vertically or in series, feeding the output of one learned function into the input of another learned function.

The combiner module 506 may determine which learned functions to combine, how to combine learned functions, or the like based on evaluation metadata for the learned functions from the metadata library 514, generated based on an evaluation of the learned functions using test data, as described below with regard to the function evaluator module 512. The combiner module 506 may request additional learned functions from the function generator module 404, for combining with other learned functions. For example, the combiner module 506 may request a new learned function with a particular input and/or output to combine with an existing learned function, or the like.

While the combining of learned functions may be informed by evaluation metadata for the learned functions, in certain embodiments, the combiner module 506 combines a large number of learned functions pseudo-randomly, forming a large number of combined functions. For example, the combiner module 506, in one embodiment, may determine each possible combination of generated learned functions, as many combinations of generated learned functions as possible given one or more limitations or constraints, a selected subset of combinations of generated learned functions, or the like, for evaluation by the function evaluator module 512. In certain embodiments, by generating a large number of combined learned functions, the combiner module 506 is statistically likely to form one or more combined learned functions that are useful and/or effective for the training data.

In the depicted embodiment, the predictive compiler module 406 includes an extender module 508. The extender module 508, in certain embodiments, is configured to add one or more layers to a learned function. For example, the extender module 508 may extend a learned function or combined learned function by adding a probabilistic model layer, such as a Bayesian belief network layer, a Bayes classifier layer, a Boltzmann layer, or the like.

Certain classes of learned functions, such as probabilistic models, may be configured to receive either instances of one or more features as input, or the output results of other learned functions, such as a classification and a confidence metric, an inferred function, a regression function, an answer, a prediction, a recognized pattern, a rule, a recommendation, or the like. The extender module 508 may use these types of learned functions to extend other learned functions. The extender module 508 may extend learned functions generated by the function generator module 404 directly, may extend combined learned functions from the combiner module 506, may extend other extended learned functions, may extend synthesized learned functions from the synthesizer module 510, or the like.

In one embodiment, the extender module 508 determines which learned functions to extend, how to extend learned functions, or the like based on evaluation metadata from the metadata library 514. The extender module 508, in certain embodiments, may request one or more additional learned functions from the function generator module 404 and/or one or more additional combined learned functions from the combiner module 506, for the extender module 508 to extend.

While the extending of learned functions may be informed by evaluation metadata for the learned functions, in certain embodiments, the extender module 508 generates a large number of extended learned functions pseudo-randomly. For example, the extender module 508, in one embodiment, may extend each possible learned function and/or combination of learned functions, may extend a selected subset of learned functions, may extend as many learned functions as possible given one or more limitations or constraints, or the like, for evaluation by the function evaluator module 512. In certain embodiments, by generating a large number of extended learned functions, the extender module 508 is statistically likely to form one or more extended learned functions and/or combined extended learned functions that are useful and/or effective for the training data.

In the depicted embodiment, the predictive compiler module 406 includes a synthesizer module 510. The synthesizer module 510, in certain embodiments, is configured to organize a subset of learned functions into the predictive ensemble 504, as synthesized learned functions 524. In a further embodiment, the synthesizer module 510 includes evaluation metadata from the metadata library 514 of the function evaluator module 512 in the predictive ensemble 504 as a synthesized metadata rule set 522, so that the predictive ensemble 504 includes synthesized learned functions 524 and evaluation metadata, the synthesized metadata rule set 522, for the synthesized learned functions 524.

The learned functions that the synthesizer module 510 synthesizes or organizes into the synthesized learned functions 524 of the predictive ensemble 504, may include learned functions directly from the function generator module 404, combined learned functions from the combiner module 506, extended learned functions from the extender module 508, combined extended learned functions, or the like. As described below, in one embodiment, the function selector module 516 selects the learned functions for the synthesizer module 510 to include in the predictive ensemble 504. In certain embodiments, the synthesizer module 510 organizes learned functions by preparing the learned functions and the associated evaluation metadata for processing workload data to reach a result. For example, as described below, the synthesizer module 510 may organize and/or synthesize the synthesized learned functions 524 and the synthesized metadata rule set 522 for the orchestration module 520 to use to direct workload data through the synthesized learned functions 524 to produce a result.

In one embodiment, the function evaluator module 512 evaluates the synthesized learned functions 524 that the synthesizer module 510 organizes, and the synthesizer module 510 synthesizes and/or organizes the synthesized metadata rule set 522 based on evaluation metadata that the function evaluation module 512 generates during the evaluation of the synthesized learned functions 524, from the metadata library 514 or the like.

In the depicted embodiment, the predictive compiler module 406 includes a function evaluator module 512. The function evaluator module 512 is configured to evaluate learned functions using test data, or the like. The function evaluator module 512 may evaluate learned functions generated by the function generator module 404, learned functions combined by the combiner module 506 described above, learned functions extended by the extender module 508 described above, combined extended learned functions, synthesized learned functions 524 organized into the predictive ensemble 504 by the synthesizer module 510 described above, or the like.

Test data for a learned function, in certain embodiments, comprises a different subset of the initialization data for the learned function than the function generator module 404 used as training data. The function evaluator module 512, in one embodiment, evaluates a learned function by inputting the test data into the learned function to produce a result, such as a classification, a confidence metric, an inferred function, a regression function, an answer, a prediction, a recognized pattern, a rule, a recommendation, or another result.

Test data, in certain embodiments, comprises a subset of initialization data, with a feature associated with the requested result removed, so that the function evaluator module 512 may compare the result from the learned function to the instances of the removed feature to determine the accuracy and/or effectiveness of the learned function for each test instance. For example, if a client 104 has requested a predictive ensemble 504 to predict whether a customer will be a repeat customer, and provided historical customer information as initialization data, the function evaluator module 512 may input a test data set comprising one or more features of the initialization data other than whether the customer was a repeat customer into the learned function, and compare the resulting predictions to the initialization data to determine the accuracy and/or effectiveness of the learned function.

The function evaluator module 512, in one embodiment, is configured to maintain evaluation metadata for an evaluated learned function in the metadata library 514. The evaluation metadata, in certain embodiments, comprises log data generated by the function generator module 404 while generating learned functions, the function evaluator module 512 while evaluating learned functions, or the like.

In one embodiment, the evaluation metadata includes indicators of one or more training data sets that the function generator module 404 used to generate a learned function. The evaluation metadata, in another embodiment, includes indicators of one or more test data sets that the function evaluator module 512 used to evaluate a learned function. In a further embodiment, the evaluation metadata includes indicators of one or more decisions made by and/or branches taken by a learned function during an evaluation by the function evaluator module 512. The evaluation metadata, in another embodiment, includes the results determined by a learned function during an evaluation by the function evaluator module 512. In one embodiment, the evaluation metadata may include evaluation metrics, learning metrics, effectiveness metrics, convergence metrics, or the like for a learned function based on an evaluation of the learned function. An evaluation metric, learning metrics, effectiveness metric, convergence metric, or the like may be based on a comparison of the results from a learned function to actual values from initialization data, and may be represented by a correctness indicator for each evaluated instance, a percentage, a ratio, or the like. Different classes of learned functions, in certain embodiments, may have different types of evaluation metadata.

The metadata library 514, in one embodiment, provides evaluation metadata for learned functions to the feature selector module 502, the predictive correlation module 518, the combiner module 506, the extender module 508, and/or the synthesizer module 510. The metadata library 514 may provide an API, a shared library, one or more function calls, or the like providing access to evaluation metadata. The metadata library 514, in various embodiments, may store or maintain evaluation metadata in a database format, as one or more flat files, as one or more lookup tables, as a sequential log or log file, or as one or more other data structures. In one embodiment, the metadata library 514 may index evaluation metadata by learned function, by feature, by instance, by training data, by test data, by effectiveness, and/or by another category or attribute and may provide query access to the indexed evaluation metadata. The function evaluator module 512 may update the metadata library 514 in response to each evaluation of a learned function, adding evaluation metadata to the metadata library 514 or the like.

The function selector module 516, in certain embodiments, may use evaluation metadata from the metadata library 514 to select learned functions for the combiner module 506 to combine, for the extender module 508 to extend, for the synthesizer module 510 to include in the predictive ensemble 504, or the like. For example, in one embodiment, the function selector module 516 may select learned functions based on evaluation metrics, learning metrics, effectiveness metrics, convergence metrics, or the like. In another embodiment, the function selector module 516 may select learned functions for the combiner module 506 to combine and/or for the extender module 508 to extend based on features of training data used to generate the learned functions, or the like.

The predictive ensemble 504, in certain embodiments, provides predictive results for an analysis request by processing workload data of the analysis request using a plurality of learned functions (e.g., the synthesized learned functions 524). As described above, results from the predictive ensemble 504, in various embodiments, may include a classification, a confidence metric, an inferred function, a regression function, an answer, a prediction, a recognized pattern, a rule, a recommendation, and/or another result. For example, in one embodiment, the predictive ensemble 504 provides a classification and a confidence metric for each instance of workload data input into the predictive ensemble 504, or the like. Workload data, in certain embodiments, may be substantially similar to test data, but the missing feature from the initialization data is not known, and is to be solved for by the predictive ensemble 504. A classification, in certain embodiments, comprises a value for a missing feature in an instance of workload data, such as a prediction, an answer, or the like. For example, if the missing feature represents a question, the classification may represent a predicted answer, and the associated confidence metric may be an estimated strength or accuracy of the predicted answer. A classification, in certain embodiments, may comprise a binary value (e.g., yes or no), a rating on a scale (e.g., 4 on a scale of 1 to 5), or another data type for a feature. A confidence metric, in certain embodiments, may comprise a percentage, a ratio, a rating on a scale, or another indicator of accuracy, effectiveness, and/or confidence.

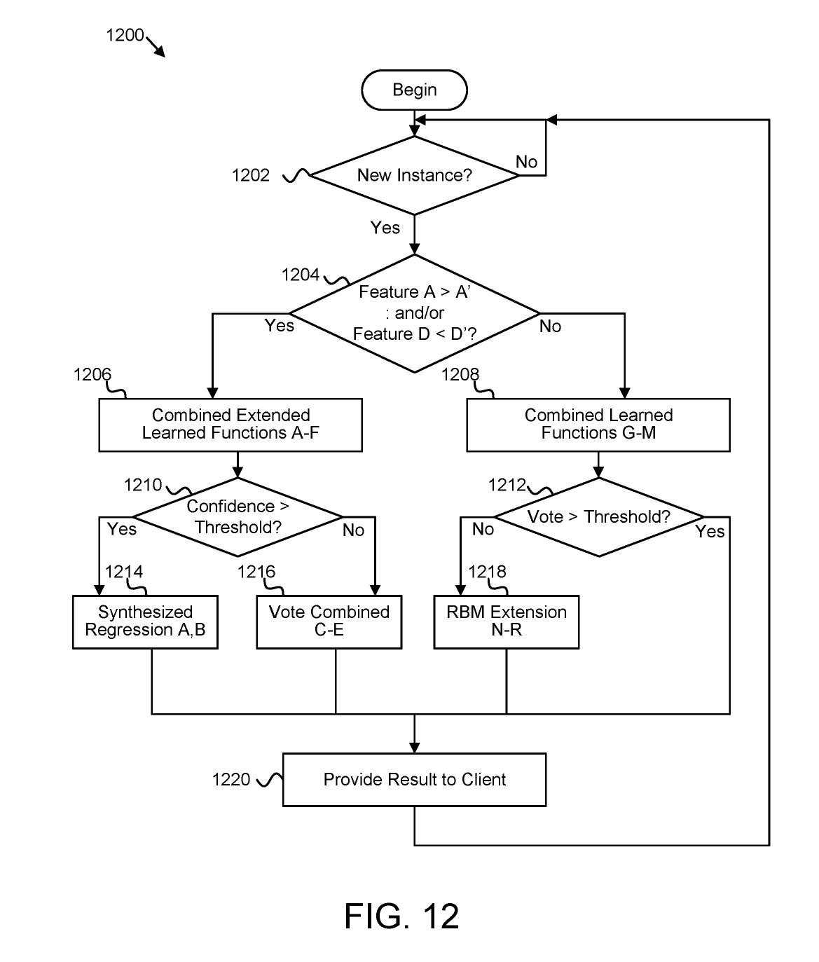

In the depicted embodiment, the predictive ensemble 504 includes an orchestration module 520. The orchestration module 520, in certain embodiments, is configured to direct workload data through the predictive ensemble 504 to produce a result, such as a classification, a confidence metric, an inferred function, a regression function, an answer, a prediction, a recognized pattern, a rule, a recommendation, and/or another result. In one embodiment, the orchestration module 520 uses evaluation metadata from the function evaluator module 512 and/or the metadata library 514, such as the synthesized metadata rule set 522, to determine how to direct workload data through the synthesized learned functions 524 of the predictive ensemble 504. As described below with regard to FIG. 12, in certain embodiments, the synthesized metadata rule set 522 comprises a set of rules or conditions from the evaluation metadata of the metadata library 514 that indicate to the orchestration module 520 which features, instances, or the like should be directed to which synthesized learned function 524.

For example, the evaluation metadata from the metadata library 514 may indicate which learned functions were trained using which features and/or instances, how effective different learned functions were at making predictions based on different features and/or instances, or the like. The synthesizer module 510 may use that evaluation metadata to determine rules for the synthesized metadata rule set 522, indicating which features, which instances, or the like the orchestration module 520 the orchestration module 520 should direct through which learned functions, in which order, or the like. The synthesized metadata rule set 522, in one embodiment, may comprise a decision tree or other data structure comprising rules which the orchestration module 520 may follow to direct workload data through the synthesized learned functions 524 of the predictive ensemble 504.

FIG. 6 depicts one embodiment of a system 600 for a predictive analytics factory. The system 600, in the depicted embodiment, includes several clients 104 in communication with a predictive analytics module 102 over a data network 106, substantially as described above with regard to FIG. 1, where the predictive analytics module 102 includes a prediction module 202. The prediction module 202 of FIG. 6 is substantially similar to the prediction module 202 of FIG. 5, but further includes an interface module 602, a predictive analytics factory 604, and a data repository 606.

The interface module 602, in certain embodiments, is configured to receive requests from clients 104, to provide results to a client 104, or the like. The interface module 602 may provide a predictive analytics interface to clients 104, such as an API, a shared library, a hardware command interface, or the like, over which clients 104 may make requests and receive results. The interface module 602 may support new ensemble requests from clients 104, allowing clients 104 to request generation of a new predictive ensemble from the predictive analytics factory 604 or the like. As described above, a new ensemble request may include initialization data; one or more ensemble parameters; a feature, query, question or the like for which a client 104 would like a predictive ensemble 504 to predict a result; or the like. The interface module 602 may support analysis requests for a result from a predictive ensemble 504. As described above, an analysis request may include workload data; a feature, query, question or the like; a predictive ensemble 504; or may include other analysis parameters.

In certain embodiments, the prediction module 202 may maintain a library of generated predictive ensembles 504, from which clients 104 may request results. In such embodiments, the interface module 602 may return a reference, pointer, or other identifier of the requested predictive ensemble 504 to the requesting client 104, which the client 104 may use in analysis requests. In another embodiment, in response to the predictive analytics factory 604 generating a predictive ensemble 504 to satisfy a new ensemble request, the interface module 602 may return the actual predictive ensemble 504 to the client 104, for the client 104 to manage, and the client 104 may include the predictive ensemble 504 in each analysis request.

The interface module 602 may cooperate with the predictive analytics factory 604 to service new ensemble requests, may cooperate with the predictive ensemble 504 to provide a result to an analysis request, or the like. The predictive analytics factory 604, in the depicted embodiment, includes the function generator module 404, the feature selector module 502, the predictive correlation module 518, and the predictive compiler module 406, as described above. The predictive analytics factory 604, in the depicted embodiment, also includes a data repository 606.

The data repository 606, in one embodiment, stores initialization data, so that the function generator module 404, the feature selector module 502, the predictive correlation module 518, and/or the predictive compiler module 406 may access the initialization data to generate, combine, extend, evaluate, and/or synthesize learned functions and predictive ensembles 504. The data repository 606 may provide initialization data indexed by feature, by instance, by training data subset, by test data subset, by new ensemble request, or the like. By maintaining initialization data in a data repository 606, in certain embodiments, the predictive analytics factory 604 ensures that the initialization data is accessible throughout the predictive ensemble 504 building process, for the function generator module 404 to generate learned functions, for the feature selector module 502 to determine which features should be used in the predictive ensemble 504, for the predictive correlation module 518 to determine which features correlate with the highest confidence metrics, for the combiner module 506 to combine learned functions, for the extender module 508 to extend learned functions, for the function evaluator module 512 to evaluate learned functions, for the synthesizer module 510 to synthesize learned functions 524 and/or metadata rule sets 522, or the like.

In the depicted embodiment, the data receiver module 402 is integrated with the interface module 602, to receive initialization data, including training data and test data, from new ensemble requests. The data receiver module 402 stores initialization data in the data repository 606. The function generator module 404 is in communication with the data repository 606, in one embodiment, so that the function generator module 404 may generate learned functions based on training data sets from the data repository 606. The feature selector module 402 and/or the predictive correlation module 518, in certain embodiments, may cooperate with the function generator module 404 and/or the predictive compiler module 406 to determine which features to use in the predictive ensemble 404, which features are most predictive or correlate with the highest confidence metrics, or the like.

Within the predictive compiler module 406, the combiner module 506, the extender module 508, and the synthesizer module 510 are each in communication with both the function generator module 404 and the function evaluator module 512. The function generator module 404, as described above, may generate an initial large amount of learned functions, from different classes or the like, which the function evaluator module 512 evaluates using test data sets from the data repository 606. The combiner module 506 may combine different learned functions from the function generator module 404 to form combined learned functions, which the function evaluator module 512 evaluates using test data from the data repository 606. The combiner module 506 may also request additional learned functions from the function generator module 404.

The extender module 508, in one embodiment, extends learned functions from the function generator module 404 and/or the combiner module 506. The extender module 508 may also request additional learned functions from the function generator module 404. The function evaluator module 512 evaluates the extended learned functions using test data sets from the data repository 606. The synthesizer module 510 organizes, combines, or otherwise synthesizes learned functions from the function generator module 404, the combiner module 506, and/or the extender module 508 into synthesized learned functions 524 for the predictive ensemble 504. The function evaluator module 512 evaluates the synthesized learned functions 524, and the synthesizer module 510 organizes or synthesizes the evaluation metadata from the metadata library 514 into a synthesized metadata rule set 522 for the synthesized learned functions 524.

As described above, as the function evaluator module 512 evaluates learned functions from the function generator module 404, the combiner module 506, the extender module 508, and/or the synthesizer module 510, the function evaluator module 512 generates evaluation metadata for the learned functions and stores the evaluation metadata in the metadata library 514. In the depicted embodiment, in response to an evaluation by the function evaluator module 512, the function selector module 516 selects one or more learned functions based on evaluation metadata from the metadata library 514. For example, the function selector module 516 may select learned functions for the combiner module 506 to combine, for the extender module 508 to extend, for the synthesizer module 510 to synthesize, or the like.

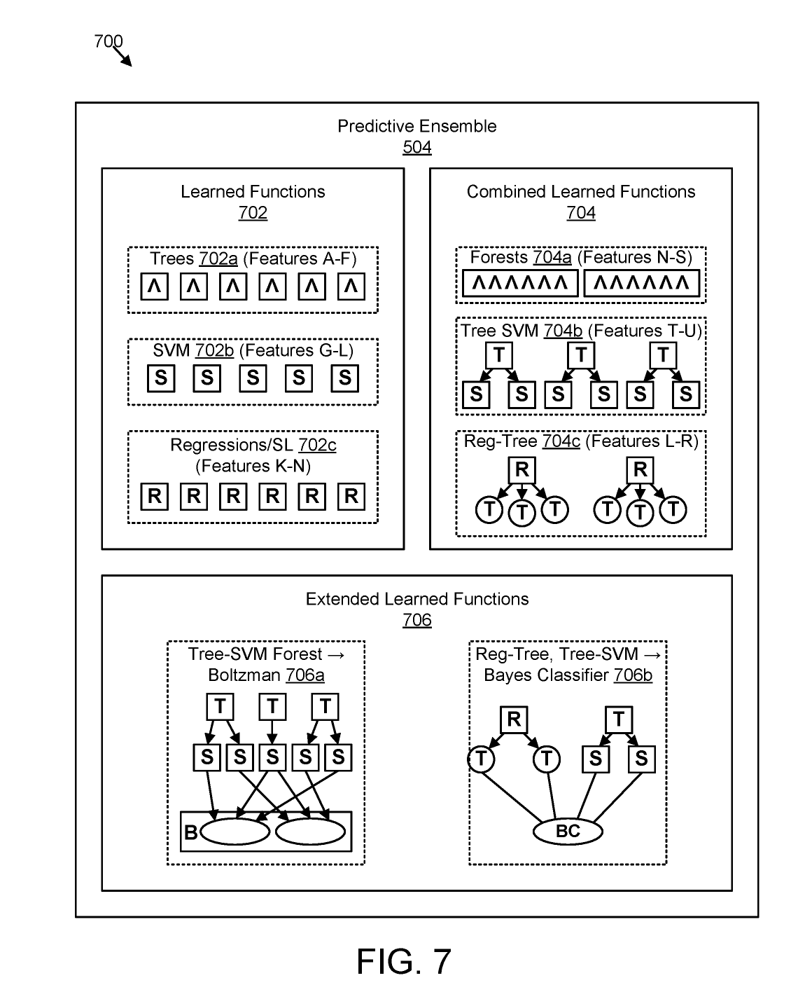

FIG. 7 depicts one embodiment 700 of learned functions 702, 704, 706 for a predictive ensemble 504. The learned functions 702, 704, 706 are presented by way of example, and in other embodiments, other types and combinations of learned functions may be used, as described above. Further, in other embodiments, the predictive ensemble 404 may include an orchestration module 520, a synthesized metadata rule set 522, or the like. In one embodiment, the function generator module 404 generates the learned functions 702. The learned functions 702, in the depicted embodiment, include various collections of selected learned functions 702 from different classes including a collection of decision trees 702a, configured to receive or process a subset A-F of the feature set of the predictive ensemble 504, a collection of support vector machines (“SVMs”) 702b with certain kernels and with an input space configured with particular subsets of the feature set G-L, and a selected group of regression models 702c, here depicted as a suite of single layer (“SL”) neural nets trained on certain feature sets K-N.

The example combined learned functions 704, combined by the combiner module 506 or the like, include various instances of forests of decision trees 704a configured to receive or process features N-S, a collection of combined trees with support vector machine decision nodes 704b with specific kernels, their parameters and the features used to define the input space of features T-U, as well as combined functions 704c in the form of trees with a regression decision at the root and linear, tree node decisions at the leaves, configured to receive or process features L-R.

Component class extended learned functions 706, extended by the extender module 508 or the like, include a set of extended functions such as a forest of trees 706a with tree decisions at the roots and various margin classifiers along the branches, which have been extended with a layer of Boltzmann type Bayesian probabilistic classifiers. Extended learned function 706b includes a tree with various regression decisions at the roots, a combination of standard tree 704b and regression decision tree 704c and the branches are extended by a Bayes classifier layer trained with a particular training set exclusive of those used to train the nodes.

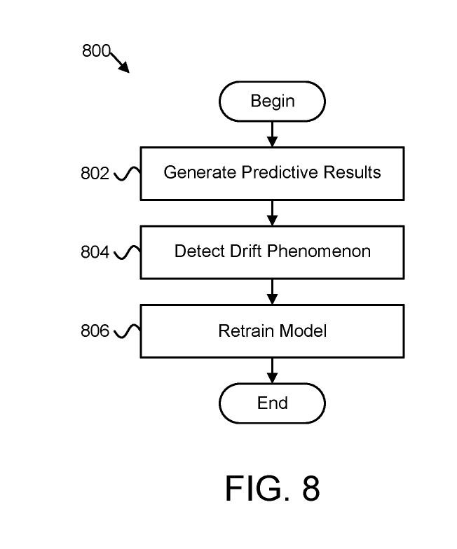

FIG. 8 is a schematic flow chart diagram illustrating one embodiment of a method 800 for predictive drift detection and correction. The method 800 begins, and a prediction module 202 generates 802 one or more predictive results by applying a model to workload data. In a certain embodiment, the model may include one or more learned functions based on training data. A drift detection module 204 detects 804 a drift phenomenon relating to the one or more predictive results. In response to detecting the drift phenomenon, a retrain module 302 retrains 806 the model based on updated training data, and the method 800 ends.

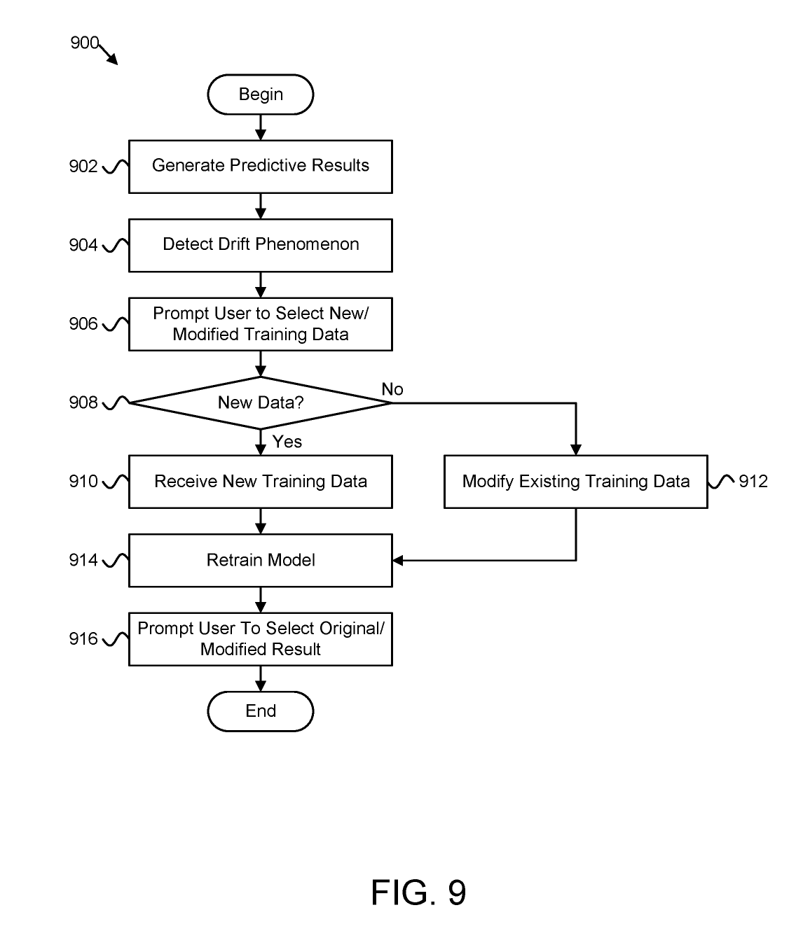

FIG. 9 is a schematic flow chart diagram illustrating another embodiment of a method 900 for predictive drift detection and correction. The method 900 begins, and a prediction module 202 generates 902 one or more predictive results by applying a model to workload data. In a certain embodiment, the model may include one or more learned functions based on training data. A drift detection module 204 detects 904 a drift phenomenon relating to the one or more predictive results. In response to detecting the drift phenomenon, a retrain module 302 prompts 906 a user to select whether to use new training data or modified training data for retraining the module. If the method 900 determines 908 that the user has selected new data, the retrain module 302 and/or the prediction module 202 receive 910 the new training data. If the method 900 determines 908 that the user has selected modified training data, the retrain module 302 and/or the prediction module 202 modify 912 existing training data. The retrain module 302 retrains 914 the model using the new or modified training data. The retrain module 302 presents a predictive result from the original model and a modified predictive result from the retrained model to a user, and prompts 916 the user to select the original model or the retrained model, and the method 900 ends.

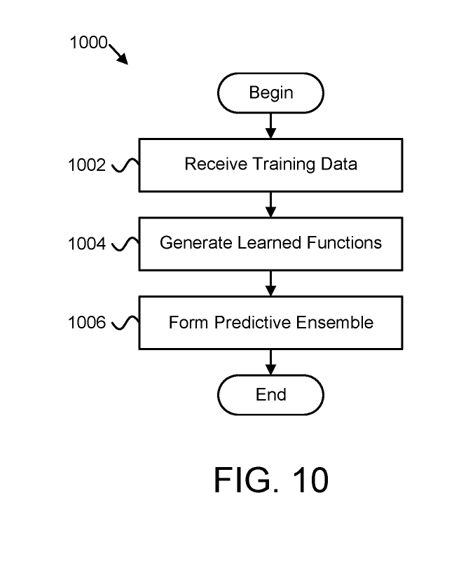

FIG. 10 depicts one embodiment of a method 1000 for a predictive analytics factory. The method 1000 begins, and the data receiver module 402 receives 1002 training data. The function generator module 404 generates 1004 a plurality of learned functions from multiple classes based on the received 1002 training data. The predictive compiler module 406 forms 1006 a predictive ensemble comprising a subset of learned functions from at least two classes, and the method 1000 ends.

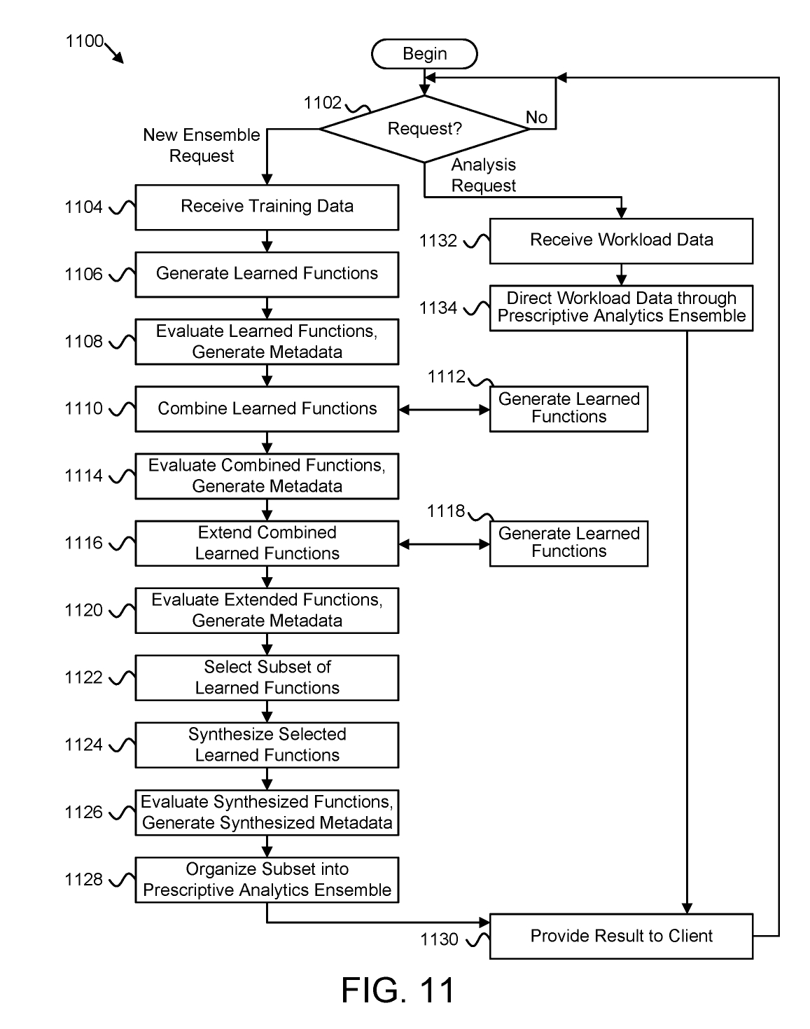

FIG. 11 depicts another embodiment of a method 1100 for a predictive analytics factory. The method 1100 begins, and the interface module 602 monitors 1102 requests until the interface module 602 receives 1102 an analytics request from a client 104 or the like.

If the interface module 602 receives 1102 a new ensemble request, the data receiver module 402 receives 1104 training data for the new ensemble, as initialization data or the like. The function generator module 404 generates 1106 a plurality of learned functions based on the received 1104 training data, from different predictive analytics classes. The function evaluator module 512 evaluates 1108 the plurality of generated 1106 learned functions to generate evaluation metadata. The combiner module 506 combines 1110 learned functions based on the metadata from the evaluation 1108. The combiner module 506 may request that the function generator module 404 generate 1112 additional learned functions for the combiner module 506 to combine.

The function evaluator module 512 evaluates 1114 the combined 1110 learned functions and generates additional evaluation metadata. The extender module 508 extends 1116 one or more learned functions by adding one or more layers to the one or more learned functions, such as a probabilistic model layer or the like. In certain embodiments, the extender module 508 extends 1116 combined 1110 learned functions based on the evaluation 1112 of the combined learned functions. The extender module 508 may request that the function generator module 404 generate 1118 additional learned functions for the extender module 508 to extend. The function evaluator module 512 evaluates 1120 the extended 1116 learned functions. The function selector module 516 selects 1122 at least two learned functions, such as the generated 1106 learned functions, the combined 1110 learned functions, the extended 1116 learned functions, or the like, based on evaluation metadata from one or more of the evaluations 1108, 1114, 1120.

The synthesizer module 510 synthesizes 1124 the selected 1122 learned functions into synthesized learned functions 524. The function evaluator module 512 evaluates 1126 the synthesized learned functions 524 to generate a synthesized metadata rule set 522. The synthesizer module 510 organizes 1128 the synthesized 1124 learned functions 524 and the synthesized metadata rule set 522 into a predictive ensemble 504. The interface module 602 provides 1130 a result to the requesting client 104, such as the predictive ensemble, a reference to the predictive ensemble, an acknowledgment, or the like, and the interface module 602 continues to monitor 1102 requests.

If the interface module 602 receives 1102 an analysis request, the data receiver module 402 receives 1132 workload data associated with the analysis request. The orchestration module 520 directs 1134 the workload data through a predictive ensemble 504 associated with the received 1102 analysis request to produce a result, such as a classification, a confidence metric, an inferred function, a regression function, an answer, a prediction, a recognized pattern, a rule, a recommendation, and/or another result. The interface module 602 provides 1130 the produced result to the requesting client 104, and the interface module 602 continues to monitor 1102 requests.

FIG. 12 depicts one embodiment of a method 1200 for directing data through a predictive ensemble. The specific synthesized metadata rule set 522 of the depicted method 1200 is presented by way of example only, and many other rules and rule sets may be used.

A new instance of workload data is presented 1202 to the predictive ensemble 504 through the interface module 602. The data is processed through the data receiver module 602 and configured for the particular analysis request as initiated by a client 104. In this embodiment the orchestration module 520 evaluates a certain set of features associates with the data instance against a set of thresholds contained within the synthesized metadata rule set 522.

A binary decision 1204 passes the instance to, in one case, a certain combined and extended function 1206 configured for features A-F or in the other case a different, parallel combined function 1208 configured to predict against a feature set G-M. In the first case 1206, if the output confidence passes 1210 a certain threshold as given by the meta-data rule set the instance is passed to a synthesized, extended regression function 1214 for final evaluation, else the instance is passed to a combined collection 1216 whose output is a weighted voted based processing a certain set of features. In the second case 1208 a different combined function 1212 with a simple vote output results in the instance being evaluated by a set of base learned functions extended by a Boltzmann type extension 1218 or, if a prescribed threshold is meet the output of the synthesized function is the simple vote. The interface module 602 provides 1220 the result of the orchestration module directing workload data through the predictive ensemble 504 to a requesting client 104 and the method 1200 continues.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. An apparatus comprising:
a prediction module that applies a model to workload data comprising one or more records to produce one or more predictive results, the model comprising one or more learned functions based on training data;
a drift detection module that detects a drift phenomenon relating to the one or more predictive results; and
a predict-time fix module that modifies at least one of the one or more predictive results in response to the drift phenomenon.

2. The apparatus of claim 1, wherein the drift phenomenon comprises workload data drift, the workload data drift comprising one or more of a missing value in the workload data, a value in the workload data that is out of a range established by the training data, a value that violates a threshold based on the training data, and a statistic that violates a threshold based on the training data, the statistic based on a set of values in a plurality of records.

3. The apparatus of claim 1, wherein the drift phenomenon comprises output drift in the one or more predictive results, the output drift comprising one or more of a predictive result that violates a threshold and a statistic for a set of predictive results that violates the threshold, the threshold based on one or more of: prior predictive results, outcomes in the training data, and outcomes corresponding to the one or more predictive results.

4. The apparatus of claim 1, wherein the predict-time fix module modifies at least one of the one or more predictive results to include an indicator of the drift phenomenon.

5. The apparatus of claim 4, wherein the indicator identifies one or more of a record and a predictive result to which the drift phenomenon relates.

6. The apparatus of claim 4, wherein the indicator identifies a feature to which the drift phenomenon relates for a plurality of records corresponding to a plurality of the predictive results.

7. The apparatus of claim 4, wherein the indicator provides instructions to a user for responding to the drift phenomenon.

8. The apparatus of claim 4, wherein the indicator comprises a comparison of data values in the workload data to a prior set of data values.

9. The apparatus of claim 4, wherein the indicator comprises a ranking of a feature affected by the drift phenomenon based on the feature's significance in the model relative to at least one feature of the workload data other than the feature affected by the drift phenomenon.

10. The apparatus of claim 1, wherein the predict-time fix module modifies at least one of the one or more predictive results to include one or more updated results based on reapplying the model to modified workload data, the modified workload data comprising one or more of the workload data with one or more data values removed, the workload data with one or more data values replaced by imputed data values, and replacement workload data provided by a user.

11. The apparatus of claim 10 wherein a modified predictive result includes a comparison between an updated result and a corresponding non-updated result.

12. The apparatus of claim 1, further comprising a retrain module that retrains the model based on updated training data, in response to detecting the drift phenomenon.

13. The apparatus of claim 12, wherein the updated training data comprises new training data obtained from a user.

14. The apparatus of claim 12, wherein the retrain module modifies the training data to produce the updated training data, wherein modifying the training data comprises one or more of removing a feature affected by the drift phenomenon from the training data and selecting records in the training data consistent with the drift phenomenon.

15. A method comprising:
generating one or more predictive results by applying a model to workload data comprising one or more records, the model comprising one or more learned functions based on training data;
detecting a drift phenomenon relating to the one or more predictive results; and
retraining the model based on updated training data, in response to detecting the drift phenomenon.

16. The method of claim 15, wherein the updated training data comprises new training data obtained from a user.

17. The method of claim 15, further comprising modifying the training data to produce the updated training data, wherein modifying the training data comprises one or more of removing a feature affected by the drift phenomenon from the training data and selecting records in the training data consistent with the drift phenomenon.

18. The method of claim 15, further comprising prompting a user to select whether to use new training data or modified training data as the updated training data.

19. The method of claim 15, further comprising presenting one of the predictive results from the original model and a modified predictive result from the retrained model to a user, and prompting the user to select one of the original model and the retrained model.

20. A computer program product comprising a computer readable storage medium storing computer usable program code executable to perform operations, the operations comprising:
applying a model to workload data comprising one or more records to produce one or more predictive results, the model comprising one or more learned functions based on training data;
detecting a drift phenomenon relating to the one or more predictive results;
modifying at least one of the one or more predictive results in response to the drift phenomenon; and
retraining the model based on updated training data, in response to detecting the drift phenomenon.
